(19) United States
(12) Patent Application Publication
(10) Pub. No.: US 2025/0023219 A1
(43) Pub. Date: Jan. 16, 2025

(54) WAVE CONTROL MEDIUM, METAMATERIAL, ELECTROMAGNETIC WAVE CONTROL MEMBER, SENSOR, ELECTROMAGNETIC WAVE WAVEGUIDE, COMPUTATION ELEMENT, TRANSMITTING/RECEIVNG DEVICE, LIGHT-RECEIVING/EMITTING DEVICE, ENERGY ABSORPTION MATERIAL, BLACKBODY MATERIAL, EXTINCTION MATERIAL, ENERGY CONVERSION MATERIAL, ELECTRIC WAVE LENS, OPTICAL LENS, COLOR FILTER, FREQUENCY SELECTION FILTER, ELECTROMAGNETIC WAVE REFLECTION MATERIAL, BEAM PHASE CONTROL DEVICE, ELECTROSPINNING DEVICE, DEVICE FOR MANUFACTURING WAVE CONTROL

(71) Applicant: Sony Group Corporation, Tokyo (JP)

(72) Inventor: Eri IGARASHI, Tokyo (JP)

(21) Appl. No.: 18/705,254

(22) PCT Filed: Sep. 12, 2022
(86) PCT No.: PCT/JP2022/034097

§ 371 Date: Apr. 26, 2024

(30) Foreign Application Priority Data
Oct. 29, 2021 (JP) 2021-177401

(51) Int. Cl. H01P 1/20; B82Y 20/00; B82Y 40/00; H01P 3/16; H01P 3/20; H01P 11/00; H01Q 1/38

(52) U.S. Cl. CPC H01P 1/2005; B82Y 20/00; B82Y 40/00; H01P 3/16; H01P 3/20; H01P 11/006; H01P 11/007; H01Q 1/38

(57) ABSTRACT

Provided is a wave control medium capable of controlling waves while miniaturizing and expanding the bandwidth of metamaterials or the like. The wave control medium according to the present technique includes a three-dimensional structure that includes a combination of a plurality of microstructures. The present technique makes it possible to provide a wave control medium capable of controlling waves while miniaturizing and expanding the bandwidth of metamaterials or the like.

### TECHNICAL FIELD

The present technique relates to a technique using a wave control medium or the like and, more specifically, to a technique for controlling waves using artificial structures.

### BACKGROUND ART

Conventionally, it has been proposed to use metamaterials with properties, such as a negative refractive index, for reflection, shielding, absorption, phase modulation, and the like of various waves, such as electromagnetic waves and sound waves. Here, a metamaterial is an artificial structure that produces a function that cannot be exhibited by naturally occurring materials. A metamaterial is produced such that properties not found in nature should be expressed by arranging unit microstructures, such as metals, dielectrics, magnetic materials, semiconductors, and superconductors, at sufficiently short intervals relative to the wavelength. The thus-produced metamaterial can control the waves, such as electromagnetic waves or sound waves, by controlling the relative permittivity and the relative permeability.

A wave control medium, which is a unit structure of a metamaterial, normally has a size of about 1/10 of the wavelengths, and the function is exhibited by arranging the unit structures as an array structure of several units. When waves with a long wavelength, such as microwaves and sound waves in the visible and audible range, are handled, the structure of the metamaterial structure expands according to the wavelengths and requires a large footprint. This may cause a problem when such waves are handled in small electronic devices.

The operating principle of metamaterials is based on resonance phenomena due to the interaction of waves and structure. Therefore, the response strength is sharply reduced, resulting in a narrow-band response at frequencies other than the resonance frequency. This may cause a problem when a wideband frequency is handled simultaneously.

Thus, in light of the above problem, it is desired to simultaneously achieve miniaturization and bandwidth expansion of metamaterials in order to put metamaterials into practical use.

As a solution to miniaturization, for example, PTL 1 proposes a metamaterial provided with a plurality of first resonators each producing a negative dielectric constant with respect to a predetermined wavelength, where each of the first resonators has an inner space; a plurality of second resonators each producing negative permeability with respect to a predetermined wavelength; and a supporting member to fix the position of the first resonators and the second resonators, the supporting member fixing each of the second resonators inside the plurality of first resonators and fixing the plurality of first resonators such that the plurality of first resonators be spatially continuous.

Furthermore, as a solution to bandwidth expansion, for example, PTL 2 discloses a metamaterial device provided with a lattice structure composed of a strip dielectric instead of a lattice structure composed of a strip conductor.

### CITATION LIST

### Patent Literature

[PTL 1]
WO 2010/026907
[PTL 2]
JP 2017-152959 A

### SUMMARY

### Technical Problem

However, the techniques of PTL 1 and 2 do not propose any solution for simultaneously satisfying the miniaturization and bandwidth expansion of metamaterials, and further development of wave control media, which are unit structures of metamaterials, that simultaneously satisfy these issues has been desired.

Thus, the present technique has a main object to provide a wave control medium capable of controlling waves while miniaturizing and expanding the bandwidth of metamaterials or the like.

### Solution to Problem

The present technique provides a wave control medium with a three-dimensional structure that includes a combination of a plurality of microstructures.

At least one of the plurality of microstructures may be a three-dimensional microstructure.

The three-dimensional microstructure may be coiled.

At least two of the plurality of microstructures may be three-dimensional microstructures.

The at least two of the three-dimensional microstructures may include first and second three-dimensional microstructures extending while maintaining a distance from each other.

The first and second three-dimensional microstructures may constitute a capacitor.

The first and second three-dimensional microstructures may be electrically conductive, and at least two of the three-dimensional microstructures may further include an insulating third three-dimensional microstructure extending while being sandwiched by the first and second three-dimensional microstructures.

Each of the first, second, and third three-dimensional microstructures may be composed of at least one polymer fiber.

The first and second three-dimensional microstructures may be composed of an inorganic polymer, and the third three-dimensional microstructure may be composed of an organic polymer.

Each of the first, second, and third three-dimensional microstructures may be helical.

The first, second, and third three-dimensional microstructures may be arranged substantially coaxially.

The first, second, and third three-dimensional microstructures may extend while sandwiching the third three-dimensional microstructure by the first and second three-dimensional microstructures at least in a radial direction.

The first, second, and third three-dimensional microstructures may have different diameters.

The first, second, and third three-dimensional microstructures may extend while sandwiching the third three-dimensional microstructure by the first and second three-dimensional microstructures at least in an axial direction.

The first, second, and third three-dimensional microstructures may have an identical diameter.

The first, second, and third three-dimensional microstructures may be substantially concentrically stacked to form a single helix.

The first, second, and third three-dimensional microstructures may be spiral.

The wave control medium may further include another microstructure in any of a wire shape, a plate shape, or a sphere shape.

The wave control medium may include a plurality of three-dimensional structures composed of a combination of the first, second, and third three-dimensional microstructures.

At least two of the plurality of the three-dimensional structures may be different in size and/or shape.

Each of the plurality of the three-dimensional structure may be helical, and at least two of the plurality of the three-dimensional structure may have different diameters.

The present technique provides a metamaterial including the wave control medium described above.

In the metamaterial mentioned above, the wave control medium may be integrated in an array.

In the metamaterial mentioned above, a plurality of the wave control media may be dispersedly arranged.

In the metamaterial mentioned above, the fractional bandwidth of response may be 30% or more, and the diameter of a cross-section of the wave control medium may be less than 1/10 of the wavelength of the incident wave.

The present technique also provides an electromagnetic wave control member including the metamaterial described above.

The present technique also provides a sensor including the electromagnetic wave control member described above.

The present technique also provides an electromagnetic wave waveguide including the metamaterial described above.

The present technique also provides a computation element including the electromagnetic wave waveguide described above.

The present technique also provides a transmitting/receiving device configured to perform transmission and reception using the metamaterial described above.

The present technique also provides a light-receiving/emitting device configured to receive and emit light using the metamaterial described above.

The present technique also provides an energy absorption material including the metamaterial described above.

The present technique also provides a blackbody material including the metamaterial described above.

The present technique also provides an extinction material including the metamaterial described above.

The present technique also provides an energy conversion material including the metamaterial described above.

The present technique also provides an electric wave lens including the metamaterial described above.

The present technique also provides an optical lens including the metamaterial described above.

The present technique also provides a color filter including the metamaterial described above.

The present technique also provides a frequency selection filter including the metamaterial described above.

The present technique also provides an electromagnetic wave reflection material including the metamaterial described above.

The present technique also provides a beam phase control device including the metamaterial described above.

The present technique also provides an electrospinning device including: a plurality of nozzles configured to eject a raw material, a collector, and a power source configured to apply a voltage between the plurality of nozzles and the collector.

A composite helical structure composed of a combination of at least three helical members may be formed by converting the raw materials ejected from the plurality of nozzles into helical fibers.

The plurality of nozzles may include first and second nozzles configured to eject, as the raw material, a solution containing a complex of a metal precursor and a polymer as a solute or a melt in which the complex is molten, and a third nozzle configured to eject, as the raw material, a polymer solution containing an organic polymer as a solute or a molten polymer in which an organic polymer is molten. The raw material ejected from the plurality of nozzles may be converted into helical fibers such that the raw materials ejected from the first and second nozzles sandwich the raw material ejected from the third nozzle to produce a composite helical structure composed of a combination of at least three helical members.

The present technique also provides a device for manufacturing a wave control medium, including

the electrospinning device described above,

a heat treatment device configured to heat the composite helical structure formed by the electrospinning device.

The present technique also provides a method for manufacturing a wave control medium, including the steps of:

ejecting multiple kinds of raw materials,

forming a composite helical structure composed of a combination of at least three helical members by charging the multiple kinds of raw materials and converting the raw materials into helical fibers, and

heating the composite helical structure to selectively mineralize some of the helical members among the at least three helical members.

The multiple kinds of raw materials may include first and second raw materials that are solutions containing a complex of a metal precursor and a polymer as solutes or melt in which the complex is molten, and a third raw material that is a polymer solution containing an organic polymer as a solute or a molten polymer in which an organic polymer is molten.

The above forming step may convert the multiple kinds of raw materials into helical fibers such that the first and second raw materials sandwich the third raw material to form a composite helical structure composed of a combination of at least three helical members.

The present technique also provides a method for manufacturing a wave control medium, including a self-organization step by drying a block copolymer or s mixed polymer solution composed of a combination of different polymers.

The present technique also provides a method for manufacturing a wave control medium, including a 3D printing step of a photo-curable resin, a thermosetting resin, a light soluble resin, or a heat soluble resin.

The present technique also provides a method for manufacturing a wave control medium, including the steps of patterning metal on a substrate to form a thin metal line and spontaneously contracting the thin metal line.

The present technique also provides a method for manufacturing a wave control medium, including a spontaneous growth step of a metal structure from a surface-treated part patterned on a substrate with metal.

### BRIEF DESCRIPTION OF DRAWINGS

FIGS. 1A and 1B are diagrams for describing the point to be improved of a conventional wave control medium.

FIGS. 2A to 2C are diagrams for explaining structural examples of wave control media.

FIG. 3A is a diagram illustrating the responsiveness of a wave control medium with a two-dimensional structure. FIG. 3B is a diagram illustrating the responsiveness of a wave control medium with a three-dimensional structure.

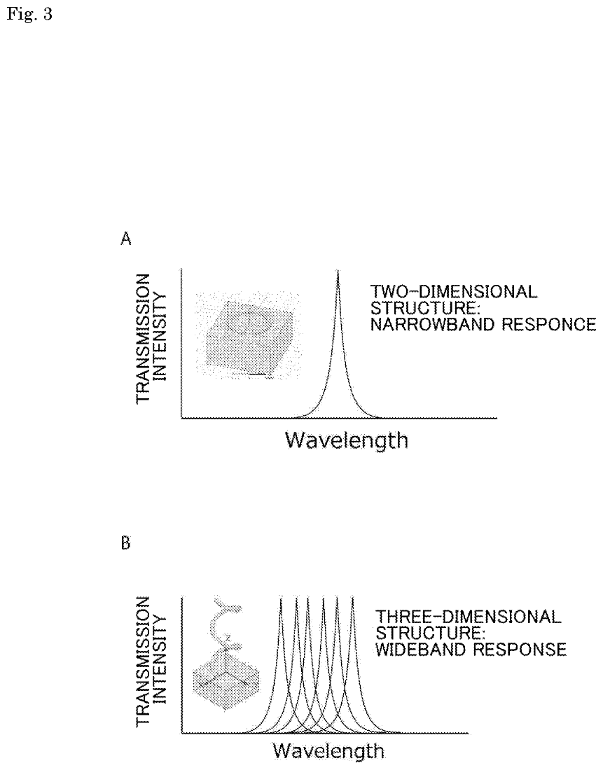

FIG. 4A is a perspective view of an example of a wave control medium of a low-density structure. FIG. 4B is a perspective view of an example of a wave control medium of a high density structure.

FIG. 5 is a perspective view of a wave control medium according to Example 1 of the first embodiment of the present technique.

FIG. 6 is a side view of the wave control medium according to Example 1 of the first embodiment of the present technique.

FIG. 7 is a plan view of the wave control medium according to Example 1 of the first embodiment of the present technique.

FIG. 8 is a block diagram illustrating a configuration example of a device for manufacturing a wave control medium according to Example 1 of the first embodiment of the present technique.

FIG. 9A is a diagram illustrating a configuration example of an electrospinning device in the device for manufacturing the wave control medium illustrated in FIG. 8. FIGS. 9B and 9C are diagrams illustrating other examples of collectors of electrospinning devices.

FIGS. 10A to 10C are perspective views illustrating configuration examples of composite helical members formed by an electrospinning device.

FIG. 11 is a flowchart for explaining one example of a method for manufacturing the wave control medium according to Example 1 of the first embodiment of the present technique.

FIG. 12 is a perspective view of a wave control medium according to Example 2 of the first embodiment of the present technique.

FIG. 13 is a side view of the wave control medium according to Example 2 of the first embodiment of the present technique.

FIG. 14 is a plan view of the wave control medium according to Example 2 of the first embodiment of the present technique.

FIG. 15 is a perspective view of a wave control medium according to Example 3 of the first embodiment of the present technique.

FIG. 16 is a side view of the wave control medium according to Example 3 of the first embodiment of the present technique.

FIG. 17 is a plan view of the wave control medium according to Example 3 of the first embodiment of the present technique.

FIG. 18 is a perspective view of a wave control medium according to Example 4 of the first embodiment of the present technique.

FIG. 19 is a perspective view of a wave control medium according to Modification Example 1 of the first embodiment of the present technique.

FIG. 20 is a perspective view of a wave control medium according to Modification Example 2 of the first embodiment of the present technique.

FIG. 21 is a perspective view of a wave control medium according to Modification Example 3 of the first embodiment of the present technique.

FIG. 22 is a perspective view of a wave control medium according to Modification Example 4 of the first embodiment of the present technique.

FIG. 23 is a perspective view of a wave control medium according to Modification Example 5 of the first embodiment of the present technique.

FIG. 24 is a perspective view of a wave control medium according to Modification Example 6 of the first embodiment of the present technique.

FIG. 25 is a cross-sectional view illustrating a configuration example of an electromagnetic absorbing sheet according to the second embodiment of the present technique.

FIG. 26A is an internal transparent perspective view of an electromagnetic absorbing sheet according to Example 1 of the second embodiment of the present technique. FIG. 26B is an internal transparent side view of an electromagnetic absorbing sheet according to Example 2 of the second embodiment of the present technique.

FIG. 27 is a cross-sectional view illustrating a configuration example of a waveguide according to the third embodiment of the present technique.

FIG. 28 is a cross-sectional view illustrating a modification example of the waveguide according to the third embodiment of the present technique.

FIG. 29 is a graph explaining the fractional bandwidth of a metamaterial having a wave control medium according to the present technique.

### DESCRIPTION OF EMBODIMENTS

Hereinafter, preferable embodiments for implementing the present technique will be described with reference to the drawings. The embodiments which will be described later illustrate examples of representative embodiments of the present technique, and any of the embodiments can be combined. The scope of the present technique is not to be construed narrowly by these. The explanations are given in the following order.
0. Introduction
1. Wave Control Medium according to Example 1 of First Embodiment (Multiplex Type)
2. Device for Manufacturing Wave Control Medium according to Example 1 of First Embodiment
3. Method for Manufacturing Wave Control Medium according to Example 1 of First Embodiment
4. Wave Control Medium according to Example 2 of First Embodiment (Juxtaposition Type)
5. Wave Control Medium according to Example 3 of First Embodiment (Stacked Type 1)
6. Wave Control Medium according to Example 4 of First Embodiment (Stacked Type 2)
7. Wave Control Medium according to Modification Examples 1 to 3 of First Embodiment (Combination with Wire Structure)
8. Wave Control Medium according to Modification Examples 4 and 5 of First Embodiment (Combination with Plate Structure)
9. Wave Control Medium according to Modification Example 6 of First Embodiment (Combination with Sphere Structure)
10. Electromagnetic Wave Absorption Member according to Examples 1 and 2 of Second Embodiment>
11. Electromagnetic Wave Waveguide according to Examples 1 and 2 of Third Embodiment>
12. Fractional Bandwidth
13. Other Modifications of First Embodiment
14. Other Applications and Uses

### 0. INTRODUCTION

### (Overview and Issues of Metamaterials)

Incidentally, in a metamaterial, wave control media, which are media to control the wave, such as electromagnetic waves and sound waves, are arranged in a dielectric as unit structures. For example, these wave control media are structures that are sufficiently smaller in size than the wavelength of the wave to be controlled (hereinafter also referred to as the “control wavelength”) and have a resonator inside.

A metamaterial with arrays of such wave control media can artificially control the relative permittivity εᵣ and/or the relative permeability μᵣ and the refractive index n(√εᵣ×√μᵣ) of the metamaterial can be controlled. In particular, in a metamaterial, the refractive index can be a negative value with respect to the wave of the desired wavelength by adjusting, for example, the shape, dimension, or the like of the wave control medium and simultaneously achieving negative permittivity and negative permeability.

A unit structure (a wave control medium) in a metamaterial normally has a size of about 1/10 of the control wavelengths, and the wave control function is exhibited by arranging the unit structures as an array of several units. For example, when waves with long wavelengths, such as microwaves and sound waves in the visible and audible range, are to be controlled, the structure of the metamaterial also becomes larger with wavelengths and requires a large footprint. This may cause a problem when small electronic devices control waves with long wavelengths.

The resonance (operation) frequency f₀ of a metamaterial is determined by an inductance L and a capacitance C when the metamaterial is described as a circuit by an LC circuit theory (f₀=½π√LC), and as the inductance L and the capacitance C are larger, the resonance frequency f₀ is lower. In other words, a highly dense structure with a large inductance L and a large capacitance C allows even small metamaterials to function with respect to longer wavelength (i.e., lower frequency) waves.

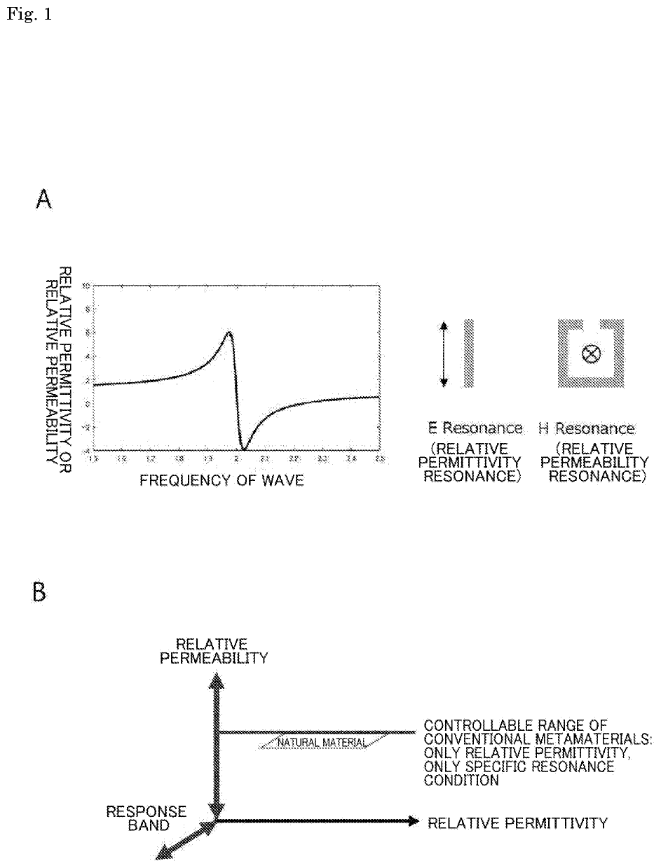

Furthermore, the operating principle of metamaterials is based on a resonance phenomenon (relative permittivity resonance and relative permeability resonance) due to the interaction between waves and structure. Therefore, the response strength relating to the control of relative permittivity and relative permeability decreases sharply at a frequency other than the resonant frequency, resulting in a narrowband response (see FIG. 1A). This may cause a problem when wide-band frequency waves are simultaneously controlled.

In particular, in conventional metamaterials, it is the relative permittivity that is substantially freely controllable among relative permittivity and relative permeability, and moreover, the relative permittivity could be substantially freely controlled only when specific resonance conditions are met. In other words, conventional metamaterials have room for improvement in terms of expanding the bandwidth of response (bandwidth expansion) over which the refractive index can be controlled with respect to natural materials (see FIG. 1B).

Thus, the present inventor has conducted intensive studies and, as a result, has developed a wave control medium according to the present technique as a wave control medium (a unit structure of metamaterials) that can achieve miniaturization and bandwidth expansion.

### (Study of Structure of Wave Control Medium)

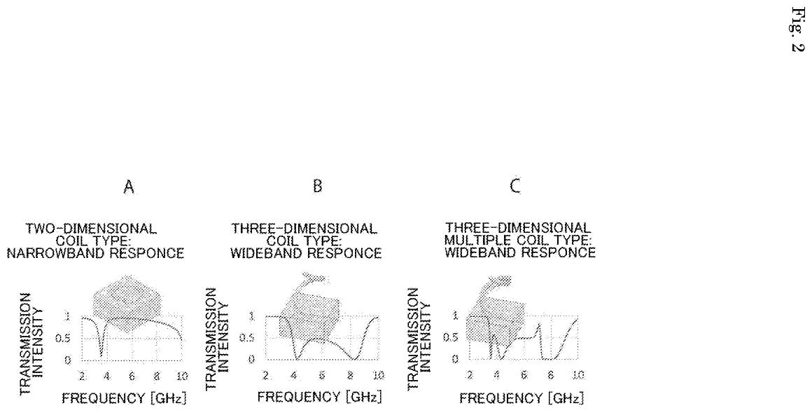

Structural examples of wave control media include a two-dimensional coil type illustrated in FIG. 2A, a three-dimensional coil type illustrated in FIG. 2B, and a three-dimensional multiple coil type illustrated in FIG. 2C. In FIG. 2A to FIG. 2C, the horizontal axis represents the frequency of a wave to be controlled, and the vertical axis represents the transmission intensity of the wave to be controlled in the wave control medium. FIG. 2A to FIG. 2C show that the two-dimensional coil-type wave control medium shows a narrowband response, whereas three-dimensional coil-type and three-dimensional multiple coil-type wave control media show a wideband response. Accordingly, three-dimensional structures are more advantageous than two-dimensional structures for bandwidth expansion.

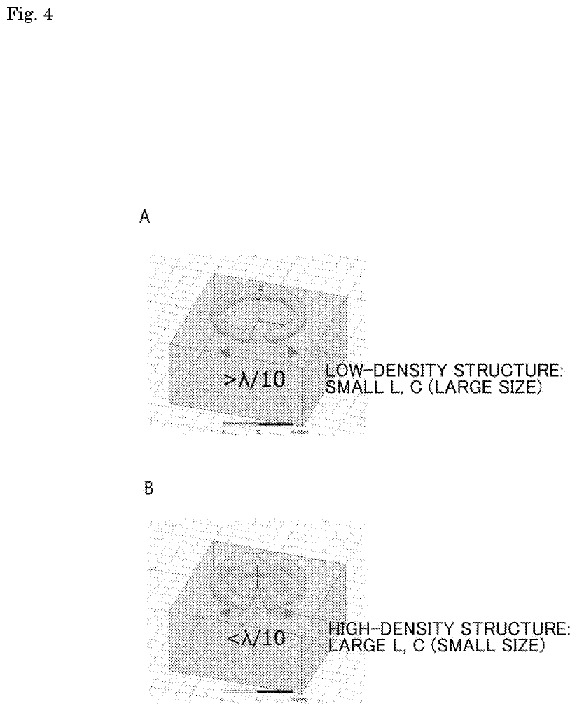

In the low-density structure illustrated in FIG. 4A, L and C are small, and the resonance frequency f₀ cannot be lowered, and the size must be larger (≥λ/10). In contrast, in the high-density structure illustrated in FIG. 4B, L and C are large, the resonance frequency f₀ can be lowered, and the size can be smaller (<λ/10).

From the above considerations, it has been concluded that adopting a three-dimensional high-density structure (three-dimensional high-density structure) is suitable for achieving miniaturization and bandwidth expansion of wave control media at a practical level.

Hereinafter, a wave control medium according to a first embodiment of the present technique will be described in detail, citing some examples.

### 1. WAVE CONTROL MEDIUM ACCORDING TO EXAMPLE 1 OF FIRST EMBODIMENT OF PRESENT TECHNIQUE (MULTIPLEX TYPE)

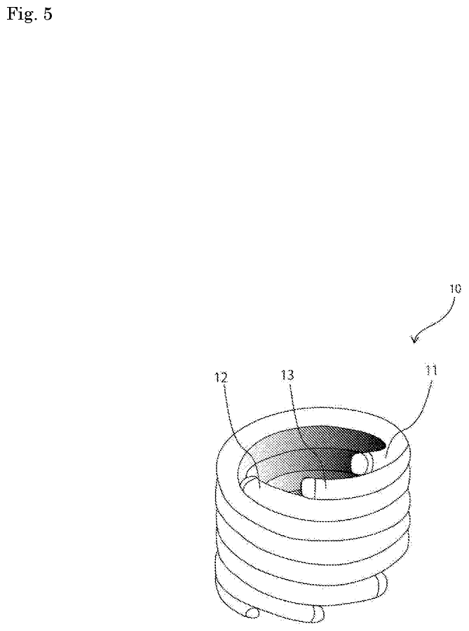

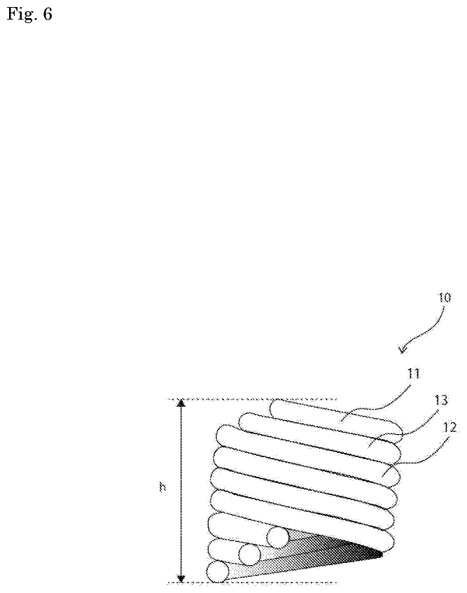

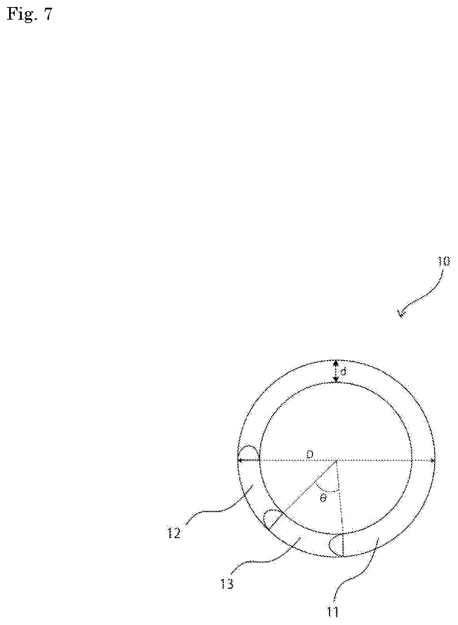

The following is an explanation about a wave control medium 10 according to Example 1 of the first embodiment of the present technique with reference to FIGS. 5 to 7. FIG. 5 is a perspective view of the wave control medium 10 according to Example 1 of the first embodiment. FIG. 6 is a side view of the wave control medium 10 according to Example 1 of the first embodiment. FIG. 7 is a plan view of the wave control medium 10 according to Example 1 of the first embodiment.

The wave control medium 10 is a unit structure of a metamaterial and can control waves, such as electromagnetic waves or sound waves.

As illustrated in FIG. 5 to FIG. 7, the wave control medium 10 has a three-dimensional structure composed of a combination of a plurality of (for example, three) microstructures 11, 12, and 13. As one example, each of the microstructures is a three-dimensional microstructure. Each of the three-dimensional microstructures is coiled, for example. Hereinafter, the microstructure 11 may also be referred to as a first three-dimensional microstructure 11, the microstructure 12 may also be referred to as a second three-dimensional microstructure 12, and the microstructure 13 may also be referred to as a third three-dimensional microstructure.

As an example, each of the first, second, and third three-dimensional microstructures 11, 12, and 13 is helical. As an example, the first, second, and third three-dimensional microstructures 11, 12, and 13 have an identical diameter. More specifically, each of the three-dimensional microstructures is substantially the same helical member (having the same helical diameter, line diameter, and pitch). That is, the wave control medium 10 constitutes an axially multiplexed multiple helical structure (composite helical structure) in which the first to third three-dimensional microstructures 11, 12, and 13, which are substantially the same helical members, are assembled around the axis with an angle θ (1° to 90°) shifted from one to another (see FIG. 7). To add more information, as one example, the first, second, and third three-dimensional microstructures 11, 12, and 13 are arranged substantially coaxially so as to be shifted from one to another in the axial direction. It is noted that at least two of the first, second, and third three-dimensional microstructures 11, 12, and 13 may not be arranged substantially coaxially.

To be detailed, as one example, the first and second three-dimensional microstructures 11 and 12 extend in the helical circumferential direction (in the circumferential direction and the axis direction) while maintaining a distance from each other in the axis direction. The third three-dimensional microstructure 13 extends in the helical circumferential direction while being sandwiched by the first and second three-dimensional microstructures 11 and 12. That is, the first, second, and third three-dimensional microstructures 11, 12, and 13 extend in the helical circumferential direction while sandwiching the third three-dimensional microstructure 13 by the first and second three-dimensional microstructures 11 and 12 at least in the axis direction (for example, the axis direction). The first and second three-dimensional microstructures 11 and 12 are electrically conductive, and the third three-dimensional microstructure 13 is insulating.

That is, electrically conductive first and second three-dimensional microstructures 11 and 12 constitute a capacitor via an insulating third three-dimensional microstructure 13.

As stated above, the wave control medium 10 can achieve a three-dimensional structure excellent in shape stability by the first to third three-dimensional microstructures 11, 12, and 13 arranged such that the third three-dimensional microstructure 13 extends while being sandwiched by the first and second three-dimensional microstructures 11 and 12.

The first and second three-dimensional microstructures 11 and 12 are formed by thin lines composed of a material selected from any one of metals, electrically conductive magnetics, semiconductors, and superconductors, or a combination of two or more of these. The material of the first and second three-dimensional microstructures 11 and 12 may be the same or different.

The third three-dimensional microstructure 13 is formed by thin lines composed of a material selected from dielectrics or insulating magnetics, or a combination of two or more of these.

As one example, each of the first, second, and third three-dimensional microstructures 11, 12, and 13 may be composed of at least one polymer fiber. Furthermore, as one example, the first and second three-dimensional microstructures 11 and 12 may be composed of inorganic polymers, and the third three-dimensional microstructure 13 may be composed of an organic polymer.

For example, the length h (see FIG. 6) of the wave control medium 10 is preferably about 1/100 to ½ of the control wavelength. For example, the helical external diameter D (see FIG. 7) of the wave control medium 10 is suitably about 1/100 to ½ of the control wavelength. For example, the line diameter d (see FIG. 7) of each three-dimensional microstructure of the wave control medium 10 is preferably 1/1000 to 1/100 of the wavelength. The line diameter of the third three-dimensional microstructure 13 is more preferably 1/1000 to 1/10.

Wave control media having composite helical structures have been known to resonate with waves having a wavelength equivalent to the length in the axis direction thereof and short waves with a 1/n fraction of the wavelength and show wideband characteristics with multiple resonance peaks broadly coupled. Furthermore, the relationship between the size of the wave control medium and a wavelength depends on the inductance and capacitance if the wave control medium is considered as an equivalent circuit, and a wave control medium with larger inductance and capacitance can be smaller.

The wave control medium 10 increases inductance by a composite helical structure and the capacitance is increased by forming a capacitor between the first and second three-dimensional microstructures 11 and 12. Accordingly, the wave control medium 10 can achieve a wave control medium with a small size achieved by a high-density structure and broadband characteristics achieved by a three-dimensional multiple resonance structure.

The wave control medium 10 can greatly reduce the size of the wave control elements (such as antennas, lenses, or speakers) with the wave control medium 10. The wave control medium 10 also makes it possible to perform complete shielding, absorption, rectification, filtering, or the like of new functions that cannot be achieved with natural materials. Furthermore, the wave control medium 10 can also exhibit the above effects not only to electromagnetic waves but also to various waves such as sound waves. In particular, the wave control medium 10 can exhibit the effect in an area with a long wavelength and a broad bandwidth.

As an example, the wave control medium 10 can be manufactured by a molecular templating method. The molecular templating method herein refers to a method for forming fine structures composed of a material selected from any one of, for example, metals, dielectrics, magnetics, semiconductors, and superconductors, or combinations of two or more of these using a fine and complex structure obtained from organic materials (such as artificial polymers/biopolymers, nanoparticles, or liquid crystal molecules) as a template. As molecular templating methods, three types of methods, which will be described below, have been mainly known.

The first one is a method for coating an organic material structure by plating or the like. The second one is a method for forming a structure from a precursor of metals, oxides, or the like using organic materials introduced in advance and converting the precursor into metals, oxides, or the like by, for example, firing or oxidizing/reducing this structure. The third one is a method for forming a structure using the phenomenon that a metal pattern bends by stress after etching the metal film prepared on a substrate such as a dielectric.

In the present embodiment, the second method is used. In this embodiment, a complex of a metal precursor and a polymer, and an organic polymer are used as the materials for the wave control medium 10.

### 2. DEVICE FOR MANUFACTURING WAVE CONTROL MEDIUM ACCORDING TO EXAMPLE 1 OF FIRST EMBODIMENT OF PRESENT TECHNIQUE

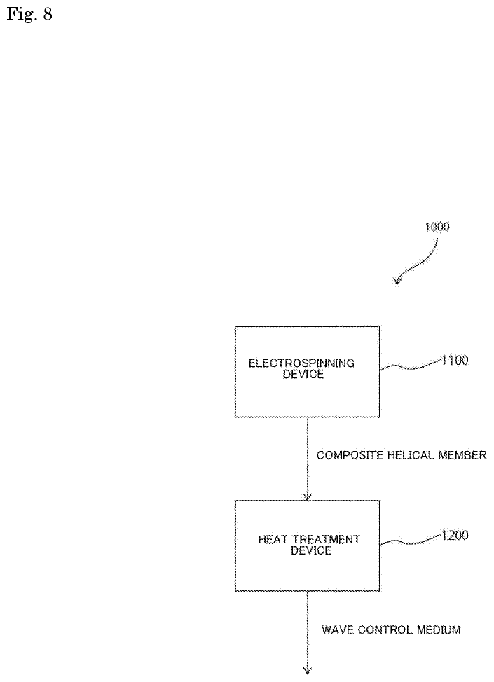

The following is an explanation about a device for manufacturing the wave control medium 10 with reference to FIGS. 8 to 10C. FIG. 8 is a block diagram illustrating a configuration example of a device for manufacturing a wave control medium according to the first embodiment of the present technique.

The device 1000 for manufacturing the wave control medium 10 is provided with an electrospinning device 1100 and a heat treatment device 1200, as illustrated in FIG. 8.

### (Electrospinning Device)

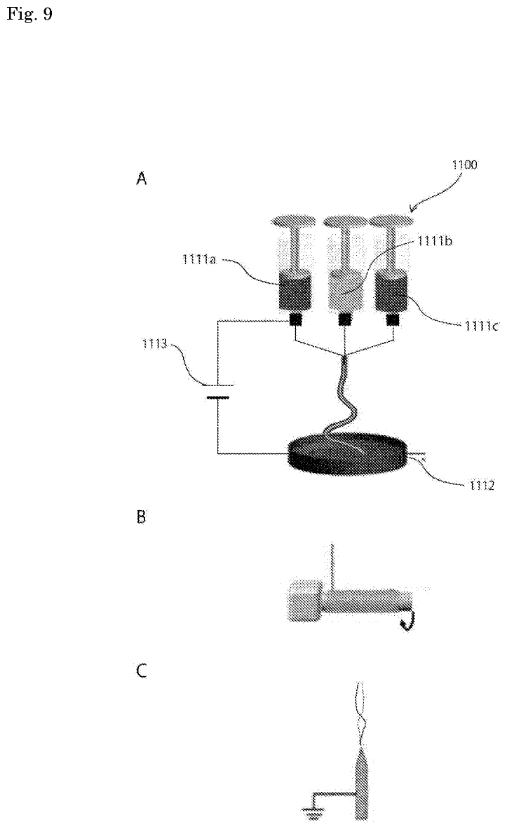

FIG. 9A is a diagram illustrating a configuration example of the electrospinning device 1100 in the device 1000 for manufacturing a wave control medium illustrated in FIG. 8. FIGS. 9B and 9C are diagrams illustrating other examples of collectors of the electrospinning device 1100.

Incidentally, an electrospinning device is a device implementing an electrospinning method. An electrospinning method is a spinning method by applying a high voltage of, for example, about 20 kV, to a nozzle and charging a polymer solution ejected from the nozzle. The advantage is that it is possible to spin microfibers and nanofibers, which are difficult to spin in normal spinning methods. Although functional fibers are the main field of application for electrospinning methods, spinning of ultrafine fibers is possible by electrospinning methods, and, therefore, the range of applications has expanded to include ion and molecule carriers, catalysts, drug delivery, batteries, capacitors, and other fields in recent years.

As one example, the electrospinning device 1100 is provided with a plurality of (for example, three) nozzles 1111 (1111a, 1111b, and 1111c) to eject a raw material, a collector 1112, and a power source 1113 to apply a voltage between the plurality of nozzles 1111 and the collector 1112.

The electrospinning device 1100 produces a composite helical structure composed of a combination of at least three (for example, three) helical members by converting raw materials ejected from the plurality of (for example, three) nozzles 1111 into helical fibers.

The plurality of nozzles 1111 include first and second nozzles 1111a and 1111b configured to eject, as the raw material, a solution containing a complex of a metal precursor and a polymer (a polymer coupling with the metal precursor) as a solute or a melt in which the complex is molten, and a third nozzle 1111c configured to eject, as the raw material, a polymer solution containing an organic polymer as a solute or a molten polymer in which an organic polymer is molten.

Specific examples of the metal precursors may include copper oxide, copper thiocyanate, copper cyanide, copper cyanate, copper carbonate, copper nitrate, copper nitrite, copper sulfate, copper phosphate, copper perchlorate, copper tetrafluoroborate, copper acetylacetonate, copper acetate, copper lactate, copper oxalate, silver oxide, silver thiocyanate, silver cyanide, silver cyanate, silver carbonate, silver nitrate, silver nitrite, silver sulfate, silver phosphate, silver perchlorate, silver tetrafluoroborate, silver acetylacetonate, silver acetate, silver lactate, silver oxalate, gold oxide, gold thiocyanate, gold cyanide, gold cyanate, gold carbonate, gold nitrate, gold nitrite, gold sulfate, gold phosphate, gold perchlorate, gold tetrafluoroborate, gold acetylacetonate, gold acetate, gold lactate, gold oxalate, and the like.

Specific examples of polymers coupling with the metal precursor may include polyvinyl acetate, polyurethane, polyurethane copolymers including polyetherurethane, cellulose acetate, cellulose derivatives, poly(methyl methacrylate) (PMMA), poly(methyl acrylate) (PMA), polyacrylic copolymers, polyvinyl acetate copolymers, polyvinyl alcohol (PVA), poly(furfuryl alcohol) (PPFA), polystyrene (PS), polystyrene copolymers, polyethylene oxide (PEO), polypropylene oxide (PPO), polyethylene oxide copolymers, polypropylene oxide copolymers, polycarbonate (PC), polyvinyl chloride (PVC), polycaprolactone, polyvinylpyrrolidone (PVP), polyvinyl fluoride, polyvinylidene fluoride copolymers, polyamide, and the like, and may be any polymer coupling with the metal precursor mentioned above.

The organic polymer mentioned above is not particularly limited.

Specific examples of solvents that serve as solvents for the above solutions may include nitric acid (aqueous solution), an aqueous zinc chloride solution, an aqueous rhodan salt solution, dimethylformamide, dimethylacetamide, dimethyl sulfoxide, γ-butyrolactone, ethylene carbonate, acetone, water, and the like and may be any solvent that dissolves the complex and the organic polymer.

The following formula (1) is indicated as a production example of a complex of a metal precursor (a copper complex, a copper organic acid salt, copper oxide, or the like) and a polymer having a site coupling with the metal precursor.

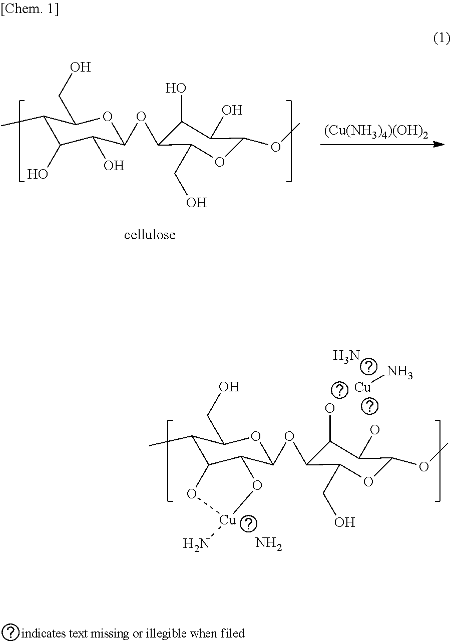

Raw materials ejected from the plurality of nozzles 1111 are charged by applying the voltage from the power source 1113 (power source voltage) between the plurality of nozzles 1111 and the collector 1112 and adsorbed on a collector 1112 while being converted into helical fibers. This forms a composite helical structure composed of a combination of a plurality of helical members.

To add more information, when the electrospinning method is implemented by the electrospinning device 1100, a desired composite helical structure can be formed by adjusting various parameters (for example, an applied voltage, the amount of solution ejected, the distance between the nozzle and the collector, the adsorption rate by the collector, and the like) of the electrospinning device 1100, environmental conditions (for example, atmosphere temperature, atmosphere humidity, atmospheric pressure, and the like), solution characteristics (for example, polymer concentration, viscosity, electrical conductivity, elasticity, surface tension, and the like).

In the examples of FIG. 9A, a plate-type collector is used as the collector 1112 but is not limited thereto. For example, a roller-type collector illustrated in FIG. 9B may also be used, and a pin needle-type collector illustrated in FIG. 9C may also be used.

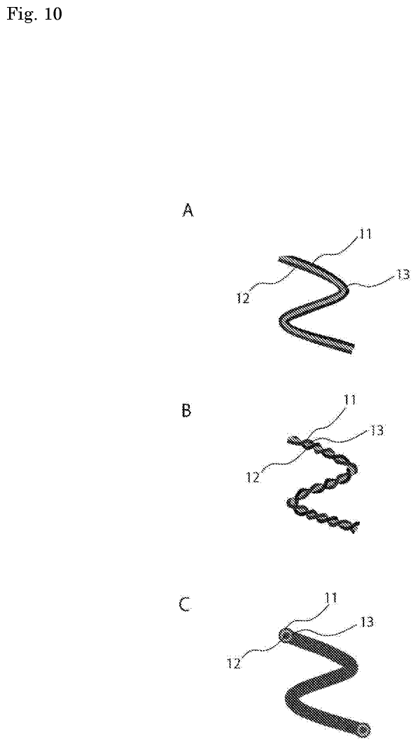

For example, if the electrospinning method is implemented in the electrospinning device 1100 by simultaneously ejecting raw materials (the first to third raw materials) from the first to third nozzles 1111a, 1111b, and 1111c, a three-dimensional structure as illustrated in FIG. 10A, in which the first and second three-dimensional microstructures 11 and 12 sandwich the third three-dimensional microstructure 13, and a composite helical structure as illustrated in FIG. 10B, in which the first and second three-dimensional microstructures 11 and 12 are intertwined with the third three-dimensional microstructure 13 in an alternating manner, can be formed.

For example, if the electrospinning method is implemented in the electrospinning device 1100 by ejecting a raw material (the third raw material) from the third nozzle 1111c and converting the raw material into helical fibers to form a helical member and then ejecting raw materials (the first and second raw materials) from the first and second nozzles 1111a and 1111b simultaneously or at different timings so as to wrap around the helical member in an alternating manner, a composite helical structure as illustrated in FIG. 10B, in which the first and second three-dimensional microstructures 11 and 12 are intertwined with the third three-dimensional microstructure 13 in an alternating manner, can be formed.

For example, if the electrospinning method is implemented in the electrospinning device 1100 by firstly ejecting a raw material (the second material) from the second nozzle 1111b and converting the second raw material into helical fibers to form a helical member, secondly ejecting a raw material (the third material) from the third nozzle 1111c and converting the third raw material into helical fibers so as to wrap around the helical member and form a two-layered helical member, and finally ejecting a raw material (the first material) from the first nozzle 1111a and converting the first raw material into helical fibers so as to wrap around the helical member and form a three-layered helical member, a composite helical structure as illustrated in FIG. 10C, in which the first to third three-dimensional microstructures 11, 12, and 13 are stacked substantially concentrically, can be formed.

### (Heat Treatment Device)

The heat treatment device 1200 heats a composite helical structure formed in the electrospinning device 1100 at, for example, 100° C. to 500° C. and selectively fires and mineralizes some of the helical members among the at least three helical members.

### 3. METHOD FOR MANUFACTURING WAVE CONTROL MEDIUM ACCORDING TO EXAMPLE 1 OF FIRST EMBODIMENT OF PRESENT TECHNIQUE

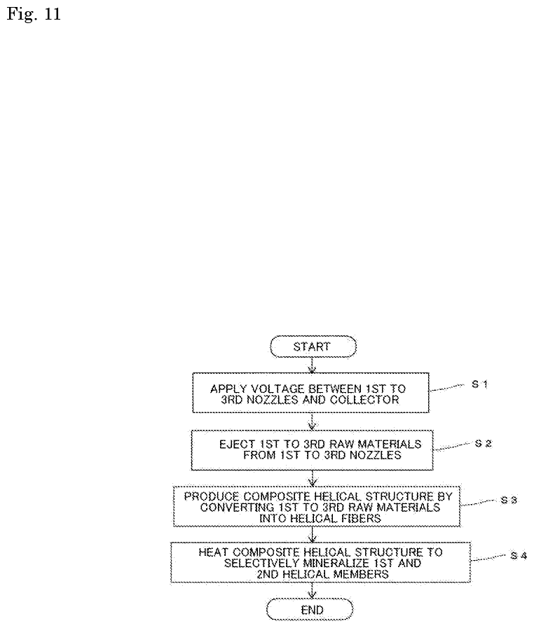

The following is an explanation about a method for manufacturing the wave control medium 10 with reference to the flow chart in FIG. 11. The method for manufacturing the wave control medium 10 is implemented using the device 1000 for manufacturing the wave control medium 10 described above.

In the first step S1, a voltage is applied between the first to third nozzles 1111a, 1111b, and 1111c, and the collector 112. Specifically, the power source 1113 is turned on.

In the next step S2, the first to third raw materials are ejected from the first to third nozzles 1111a, 1111b, and 1111c. Specifically, the first to third raw materials are simultaneously ejected from the first to third nozzles 1111a, 1111b, and 1111c, or a least one raw material is ejected at a different timing.

In the next step S3, a composite helical structure is formed by converting the first to third raw materials into helical fibers. Specifically, the first to third raw materials are charged and converted into helical fibers, thereby forming a composite helical structure composed of a combination of first to third helical members. More specifically, for example, using a method of FIG. 10A, raw materials are converted into helical fibers such that the first and second raw materials sandwich the third raw material, thereby forming a composite helical structure composed of a combination of the first to third helical members.

In the next step S4, the heat treatment device 1200 heats the composite helical structure and selectively fires and mineralizes the first and second helical members. As a result, a wave control medium 10 with a three-dimensional structure that includes a combination of the first to third three-dimensional microstructures 11, 12, and 13 is formed.

The method for manufacturing the wave control medium 10 described above includes the steps of ejecting multiple kinds of raw materials, forming a composite helical structure composed of a combination of at least three helical members by charging the multiple kinds of raw materials and converting the raw materials into helical fibers, and heating the composite helical structure to selectively mineralize some of the helical members among the at least three helical members.

The multiple kinds of raw materials include first and second raw materials that are solutions containing a complex of a metal precursor and a polymer as a solute or molten polymers that is a molten polymer in which the complex is molten, and a third raw material that is a polymer solution containing an organic polymer as a solute or a molten polymer in which an organic polymer is molten.

In the forming step, a composite helical structure composed of a combination of at least three helical members is formed by converting the multiple kinds of raw materials into helical fibers such that the first and second raw materials sandwich the third raw material.

According to the method for manufacturing the wave control medium 10, the wave control medium 10 with a complicated and fine three-dimensional microstructure that is difficult to produce in a normal method can be produced simply with good shape stability.

### 4. WAVE CONTROL MEDIUM ACCORDING TO EXAMPLE 2 OF FIRST EMBODIMENT (JUXTAPOSITION TYPE)

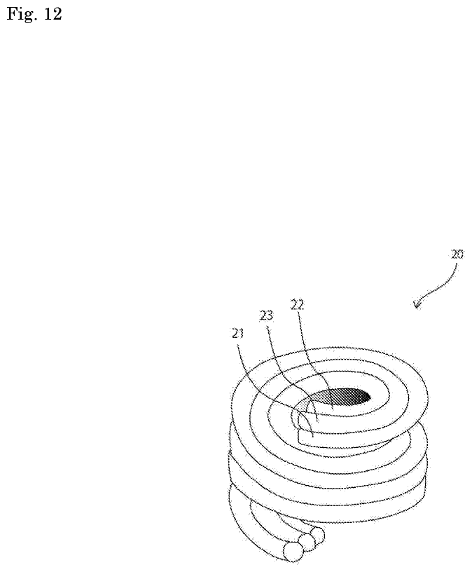

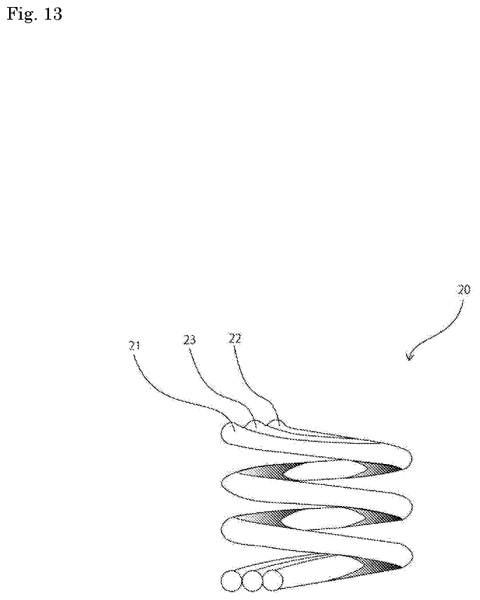

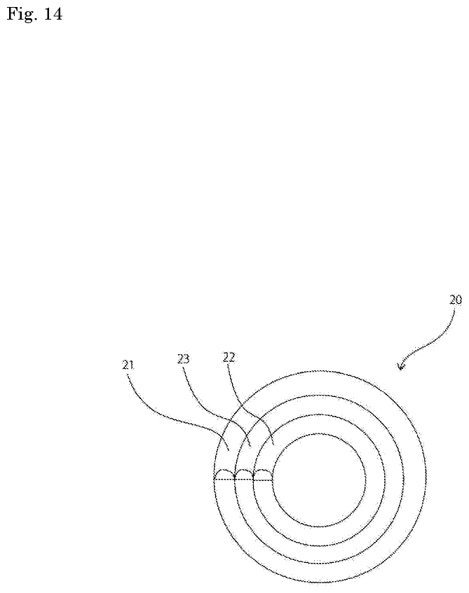

A wave control medium 20 according to Example 2 of the first embodiment of the present technique will be described with reference to FIGS. 12 to 14. FIG. 12 is a perspective view of the wave control medium 20 according to Example 2 of the first embodiment. FIG. 12 is a side view of the wave control medium 20 according to Example 2 of the first embodiment. FIG. 12 is a plan view of the wave control medium 20 according to Example 2 of the first embodiment.

As one example, the wave control medium 20 has approximately the same constitution as the wave control medium 10 according to Example 1, except that, as illustrated in FIGS. 12 to 14, a second three-dimensional microstructure 22 is placed in the inner diameter side of a first three-dimensional microstructure 21, and the first and second three-dimensional microstructures 21 and 22 extend in the helical circumferential direction while maintaining a distance from each other in the radial direction (in detail, in the helical radial direction, the direction orthogonal to the axial direction).

The wave control medium 20 has a composite helical structure composed of a combination of the first to third helical three-dimensional microstructures 21, 22, and 23. The first to third three-dimensional microstructures 21, 22, and 23 have different diameters.

As one example, in the wave control medium 20, the first to third three-dimensional microstructures 21, 22, and 23 extend in the helical circumferential direction (in the circumferential direction and the axis direction) while sandwiching the insulating third three-dimensional microstructure 23 by the electrically conductive first and second three-dimensional microstructures 21 and 22 in the radial direction (the helical radial direction).

In the wave control medium 20, the first three-dimensional microstructure 21 is in a helical shape with the largest diameter and the second three-dimensional microstructure 22 is in a helical shape with the smallest diameter among the first to third three-dimensional microstructures 21, 22, and 23.

As one example, the first, second, and third three-dimensional microstructures 21, 22, and 23 are arranged substantially coaxially. It is noted that at least two of the first, second, and third three-dimensional microstructures 21, 22, and 23 may not be arranged substantially coaxially.

The wave control medium 20 is also manufactured using the manufacturing device 1000 as with the wave control medium 10 according to Example 1. At that time, a composite helical structure composed of a combination of the first, second, and third helical members can be formed by an electrospinning method using the method illustrated in FIG. 10A.

The wave control medium 20 exhibits the same effect as the wave control medium 10 according to Example 1.

### 5. WAVE CONTROL MEDIUM ACCORDING TO EXAMPLE 3 OF FIRST EMBODIMENT (STACKED TYPE 1)

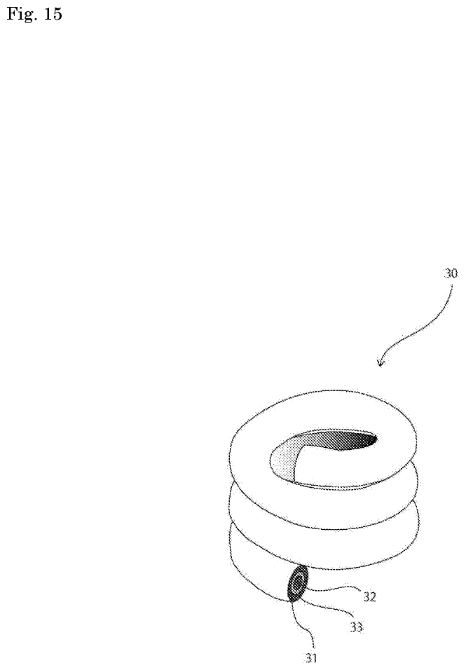

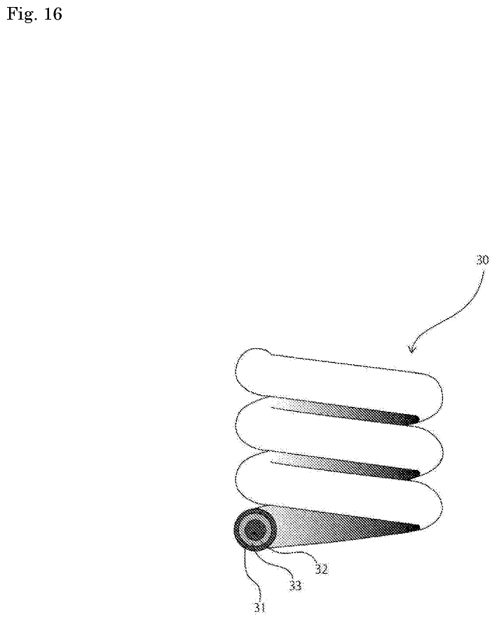

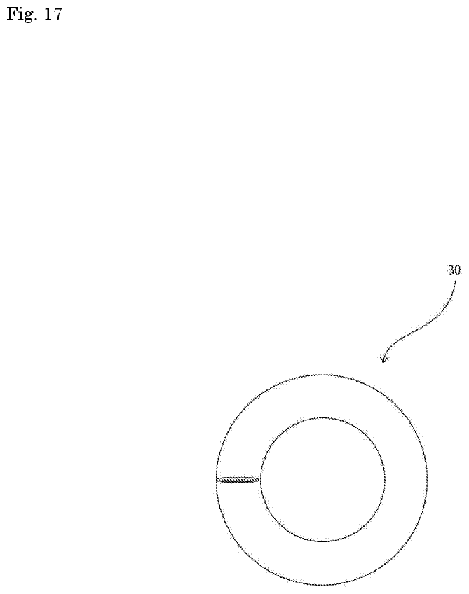

A wave control medium 30 according to Example 3 of the first embodiment of the present technique will be described with reference to FIGS. 15 to 17. FIG. 15 is a perspective view of the wave control medium 30 according to Example 3 of the first embodiment. FIG. 16 is a side view of the wave control medium 30 according to Example 3 of the first embodiment. FIG. 17 is a plan view of the wave control medium 30 according to Example 3 of the first embodiment.

The wave control medium 30 has approximately the same constitution as the wave control medium 10 according to Example 1, except that, as illustrated in FIGS. 15 to 17, first, second, and third three-dimensional microstructures 31, 32, and 33 are stacked substantially concentrically and form a single helical shape.

In the wave control medium 30, the first three-dimensional microstructure 31 is placed outermost and the second three-dimensional microstructure 32 is placed innermost among the first to third three-dimensional microstructures 31, 32, and 33.

In the wave control medium 30, the first to third three-dimensional microstructures 31, 32, and 33 extend in the helical circumferential direction (in the circumferential direction and the axis direction) while sandwiching the insulating third three-dimensional microstructure 33 by the electrically conductive first and second three-dimensional microstructures 31 and 32 in the line diameter direction.

In other words, in the wave control medium 30, the second three-dimensional microstructure 32 is covered with the third three-dimensional microstructure 33, and the third three-dimensional microstructure 33 is covered with the first three-dimensional microstructure 31. For example, the cross-sections of the first and third three-dimensional microstructures 31 and 33 are annular, and for example, the cross-section of the second three-dimensional microstructure 32 is circular.

As one example, the first, second, and third three-dimensional microstructures 31, 32, and 33 are arranged substantially coaxially. It is noted that at least two of the first, second, and third three-dimensional microstructures 31, 32, and 33 may not be arranged substantially coaxially.

The wave control medium 20 is also manufactured using the manufacturing device 1000 as with the wave control medium 10 according to Example 1. At that time, a composite helical structure composed of a combination of the first, second, and third helical members can be formed by an electrospinning method using the method illustrated in FIG. 10C.

The wave control medium 30 exhibits the same effect as the wave control medium 10 according to Example 1.

### 6. WAVE CONTROL MEDIUM ACCORDING TO EXAMPLE 4 OF FIRST EMBODIMENT (STACKED TYPE 2)

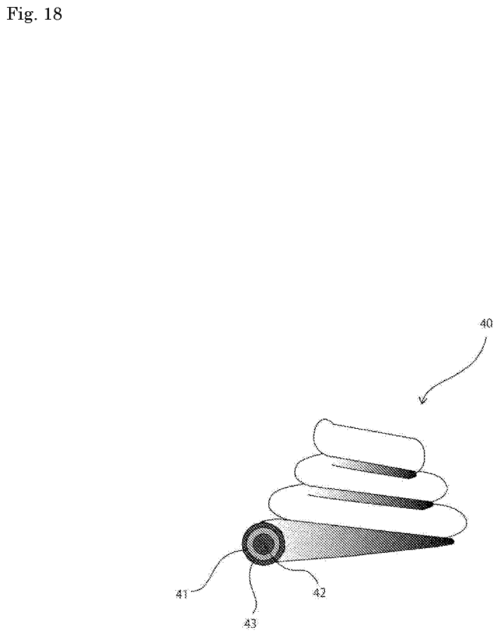

A wave control medium 40 according to Example 4 of the first embodiment of the present technique will be described with reference to FIG. 18. FIG. 18 is a perspective view of the wave control medium 40 according to Example 4 of the first embodiment.

The wave control medium 40 has approximately the same constitution as the wave control medium 30 according to Example 3, except that first, second, and third three-dimensional microstructures 41, 42, and 43 are in a spiral shape (specifically, a spiral and helical shape).

In the wave control medium 40, the first three-dimensional microstructure 41 is placed outermost and the second three-dimensional microstructure 42 is placed innermost among the first to third three-dimensional microstructures 41, 42, and 43.

In the wave control medium 40, the first to third three-dimensional microstructures 41, 42, and 43 extend in the helical circumferential direction (in the circumferential direction and the axis direction) while sandwiching the insulating third three-dimensional microstructure 43 by the electrically conductive first and second three-dimensional microstructures 41 and 42 in the line diameter direction.

In other words, in the wave control medium 40, the second three-dimensional microstructure 42 is covered with the third three-dimensional microstructure 43, and the third three-dimensional microstructure 43 is covered with the first three-dimensional microstructure 41.

As one example, the first, second, and third three-dimensional microstructures 41, 42, and 43 are arranged substantially coaxially. It is noted that at least two of the first, second, and third three-dimensional microstructures 41, 42, and 43 may not be arranged substantially coaxially.

The wave control medium 40 is also manufactured using the manufacturing device 1000 as with the wave control medium 10 according to Example 1. At that time, a composite helical structure composed of a combination of the first, second, and third helical members can be formed by an electrospinning method using the method illustrated in FIG. 10C.

The wave control medium 40 exhibits the same effect as the wave control medium 10 according to Example 1, and the diameter (helical diameter) changes along the axis direction; therefore, the response bandwidth can be further expanded. To add more information, it has been found that the smaller the helical diameter, the higher the responsiveness to the wave with a short wavelength, and the larger the helical diameter, the higher the responsiveness to the wave with a long wavelength.

Hereinafter, an example of designing a wave control medium by combining a plurality of microstructures will be explained. For example, the purpose of combining a plurality of microstructures is to form a structure in which each structure functions individually with respect to the electric and magnetic fields that constitute electromagnetic waves. In other words, the purpose is to share the functions among respective structures.

Here, functioning with respect to the electric field is to control the relative permittivity εᵣ, and functioning with respect to the magnetic field is to control the relative permeability μᵣ. Accordingly, the wave control medium according to the first embodiment can control the relative permittivity and relative permeability to the desired values by combining a plurality of microstructures.

### 7. WAVE CONTROL MEDIUM ACCORDING TO MODIFICATION EXAMPLES 1 TO 3 OF FIRST EMBODIMENT (COMBINATION WITH WIRE STRUCTURE)

### Modification Example 1

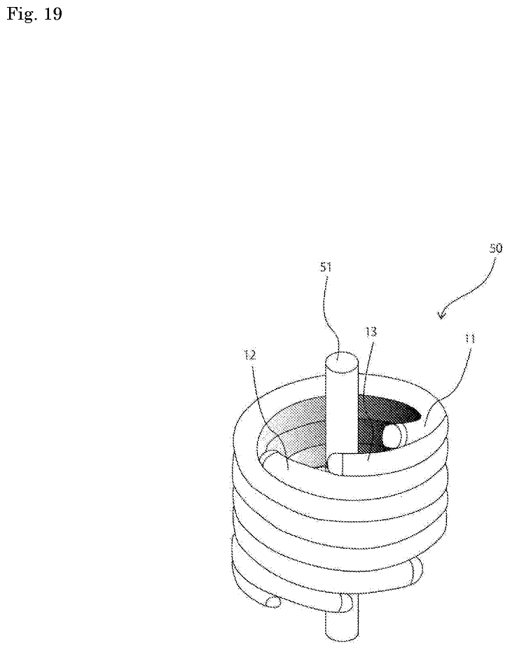

The following is an explanation about the configuration example of a wave control medium 50 according to Modification Example 1 of the first embodiment of the present technique with reference to FIG. 19. FIG. 19 is a perspective view of the wave control medium 50 according to Modification Example 1. The difference between the wave control medium 50 and the wave control medium 10 according to Example 1 of the first embodiment is that a wire structure is combined with a composite helical structure consisting of the first to third three-dimensional microstructures 11, 12, and 13. The other constitutions of the wave control medium 50 are the same as the constitutions of the wave control medium 10.

As illustrated in FIG. 19, the wave control medium 50 is provided with a thin and rod-shaped wire 51 on the inner diameter side of a composite helical structure consisting of the first to third three-dimensional microstructures 11, 12, and 13. As one example, the wire 51 is arranged substantially coaxially with the composite helical structure and separated from the composite helical structure by only a minute interval.

The wire 51 is formed by thin lines formed by a material selected from any one of metals, dielectrics, magnetic materials, semiconductors, and superconductors, or a combination of two or more of these. The material of the wire 51 may be the same as or different from the materials of the first and second three-dimensional microstructures 11 and 12. The material of the wire 51 may be the same as or different from the material of the third three-dimensional microstructure 13. Furthermore, the number of the wire 51 is not limited to one, and may be two or more.

In the wave control medium 50, the electric field direction of the applied electric wave is coincident with the vibration direction of electrons, which is the extending direction of the wire 51, and the magnetic field direction of the applied electric wave is orthogonal to the magnetic force direction induced electromagnetically by the annular current flowing through the first and second three-dimensional microstructures 11 and 12. At this time, the wire 51 functions to the magnetic field, and the first and second three-dimensional microstructures 11 and 12 function to the electric field. In other words, electrons vibrating along the wire 51 function with respect to the magnetic field. Furthermore, the first and second three-dimensional microstructures 11 and 12 function with respect to the electric field.

Here, functioning with respect to the magnetic field is to control the relative permeability μᵣ, and functioning with respect to the electric field is to control the relative permittivity εᵣ. Accordingly, the wave control medium 50 can control the relative permeability and/or relative permittivity to the desired values with a high degree of freedom by combining a plurality of microstructures.

According to the wave control medium 50, in addition to the same effect as the wave control medium 10 in Example 1, the roles of the functions can be shared, and the relative permeability and/or relative permittivity can be fine-tuned by combining the wire 51 when it is difficult to obtain the desired properties only by a composite helical structure consisting of the first to third three-dimensional microstructures 11, 12, and 13. Furthermore, the wave control medium 50 also has the role of a capacitor between the wire 51 and the composite helical structure, and, therefore, the capacitance can be increased more greatly than the wave control medium 10.

### Modification Example 2

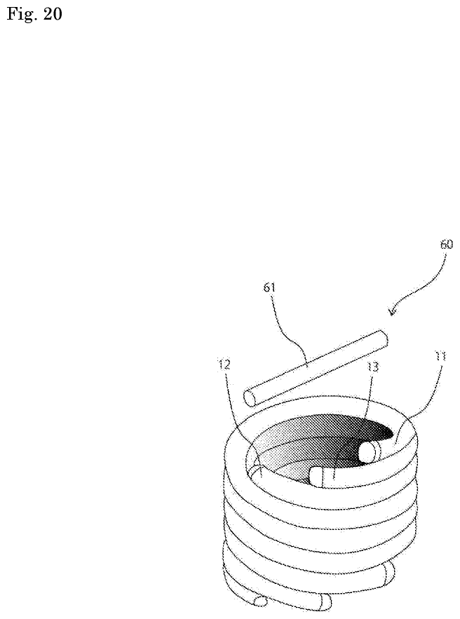

The following is an explanation about a wave control medium 60 according to Modification Example 2 of the first embodiment of the present technique with reference to FIG. 20. FIG. 20 is a perspective view of the wave control medium 60. The wave control medium 60 differs from the wave control medium 50 in that, in the wave control medium 60, the wire 61 is positioned outside the composite helical structure consisting of the first to third three-dimensional microstructures 11, 12, and 13 and extends in the direction orthogonal to the axis of the composite helical structure. The other constitutions of the wave control medium 60 are the same as the constitutions of the wave control medium 50.

As illustrated in FIG. 20, the wire 61 is a thin rod-shaped wire positioned outside the composite helical structure and extends in the direction orthogonal to the axis of the composite helical structure. The wire 61 is arranged separately from the composite helical structure by only a minute interval.

In the wave control medium 60, the electric field direction of the applied electric wave is coincident with the vibration direction of electrons, which is the extending direction of the wire 61, and the magnetic field direction of the applied electric wave is coincident with the magnetic force direction induced electromagnetically by the annular current flowing through the first and second three-dimensional microstructures 11 and 12. At this time, the wire 61 functions to the electric field, and the composite helical structure functions to the magnetic field. In other words, electrons vibrating along the wire 61 function with respect to the electric field. Furthermore, when the annular current occurs by electrons vibrating along the first and second three-dimensional microstructures 11 and 12, the magnetic force is induced on the axis of the first and second three-dimensional microstructures 11 and 12 by the principle of electromagnetic induction, and, as a result, the first and second three-dimensional microstructures 11 and 12 function with respect to the magnetic field.

As such, functioning with respect to the electric field is to control the relative permittivity εᵣ, and functioning with respect to the magnetic field is to control the relative permeability μᵣ. Accordingly, the wave control medium 60 can control the relative permittivity and/or relative permeability to the desired values by combining a plurality of microstructures.

The wave control medium 60 exhibits the same effect as the wave control medium 50.

### Modification Example 3

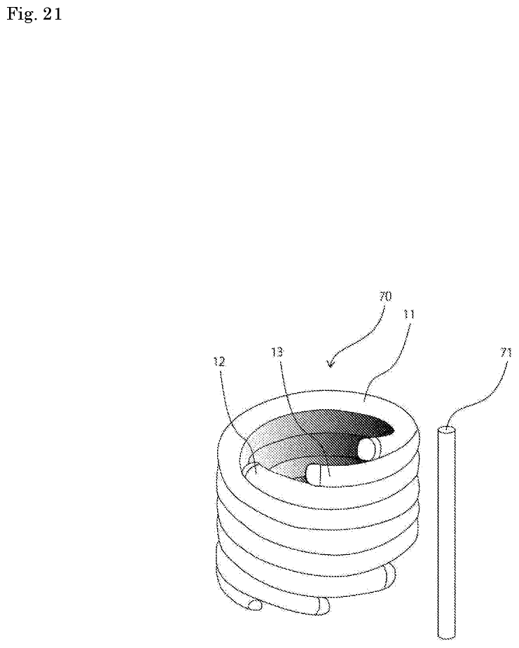

The following is an explanation about a wave control medium according to Modification Example 3 of the first embodiment of the present technique with reference to FIG. 21. FIG. 21 is a perspective view of the wave control medium 70 according to Modification Example 3. The wave control medium 70 differs from the wave control medium 50 in that, in the wave control medium 70, the wire 71 is positioned outside the composite helical structure consisting of the first to third three-dimensional microstructures 11, 12, and 13. The other constitutions of the wave control medium 70 are the same as the constitutions of the wave control medium 50.

As illustrated in FIG. 21, the wave control medium 70 is provided with a rod-shaped thin wire 71 placed outside the composite helical structure and extending in the direction parallel to the axis of the composite helical structure. The wire 71 is arranged separately from the composite helical structure by only a minute interval.

In the wave control medium 70, the electric field direction of the applied electric wave is coincident with the vibration direction of electrons, which is the extending direction of the wire 71, and the magnetic field direction of the applied electric wave is orthogonal to the magnetic force direction induced electromagnetically by the annular current flowing through the first and second three-dimensional microstructures 11 and 12. At this time, the wire 71 functions to the magnetic field, and the first and second three-dimensional microstructures 11 and 12 function to the electric field. In other words, electrons vibrating along the wire 71 function with respect to the magnetic field. Furthermore, the first and third three-dimensional microstructures 11 and 12 function with respect to the electric field.

The wave control medium 70 exhibits the same effect as the wave control medium 50.

### 8. WAVE CONTROL MEDIUM ACCORDING TO MODIFICATION EXAMPLES 4 AND 5 OF FIRST EMBODIMENT (COMBINATION WITH PLATE STRUCTURE)

### Example 4

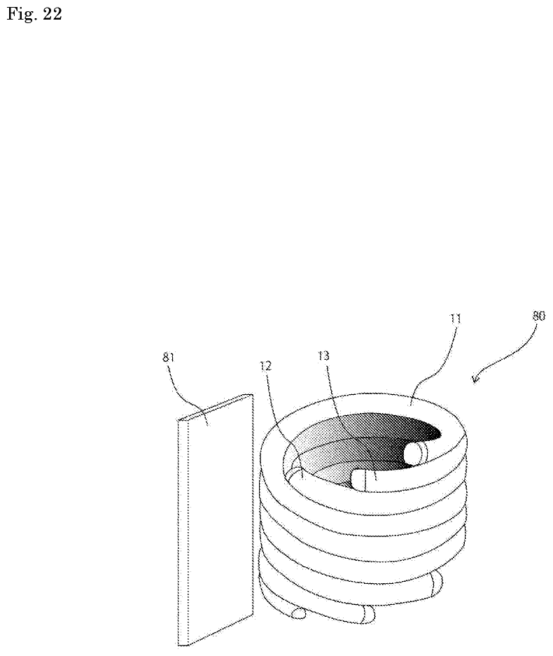

The following is an explanation about a wave control medium 80 according to Modification Example 4 of the first embodiment of the present technique with reference to FIG. 22. FIG. 22 is a perspective view illustrating the configuration example of the wave control medium 80 according to Modification Example 4. The difference between the wave control medium 80 and the wave control medium 10 according to Example 1 is that a plate structure is combined with a composite helical structure consisting of the first to third three-dimensional microstructures 11, 12, and 13. The other constitutions of the wave control medium 80 are the same as the constitutions of the wave control medium 10.

As illustrated in FIG. 22, the wave control medium 80 is provided with a thin plate-shaped plate 81 arranged substantially parallel to the axis of the composite helical structure outside the composite helical structure. The plate 81 is arranged separately from the composite helical structure by only a minute interval.

The plate 81 is formed by thin lines composed of a material selected from any one of metals, dielectrics, magnetic materials, semiconductors, and superconductors, or a combination of two or more of these. The material of the plate 81 may be the same as or different from the materials of the first and second three-dimensional microstructures 11 and 12. The material of the plate 81 may be the same as or different from the material of the third three-dimensional microstructure 13. Furthermore, the number of the plate 81 is not limited to one, and may be two or more. The plate 81 may be provided on the inner diameter side of the composite helical structure separately from the composite helical structure. Furthermore, the plate 81 and the composite helical structure have the role of a capacitor, and, therefore, the capacitance can be increased more greatly than the wave control medium 10.

In the wave control medium 80, the electric field direction of the applied electric wave is coincident with the vibration direction of electrons, which is the extending direction of the plate 81, and the magnetic field direction of the applied electric wave is orthogonal to the magnetic force direction induced electromagnetically by the annular current flowing through the first and second three-dimensional microstructures 11 and 12. At this time, the plate 81 functions with respect to the magnetic field, and the first and second three-dimensional microstructures 11 and 12 function to the electric field. In other words, electrons vibrating along the plate 81 function with respect to the magnetic field. Furthermore, the first and second three-dimensional microstructures 11 and 12 function with respect to the electric field.

Here, functioning with respect to the magnetic field is to control the relative permeability μᵣ, and functioning with respect to the electric field is to control the relative permittivity εᵣ. Accordingly, the wave control medium 80 can control the relative permeability and/or relative permittivity to the desired values with a high degree of freedom by combining a plurality of microstructures.

According to the wave control medium 80 of the present embodiment, in addition to the same effect as the wave control medium 10 according to the first embodiment, the roles of the functions can be shared, and the relative permeability and/or relative permittivity can be fine-tuned by combining the plate 81 when it is difficult to obtain the desired properties only by the first and second three-dimensional microstructures 11 and 12.

### Modification Example 5

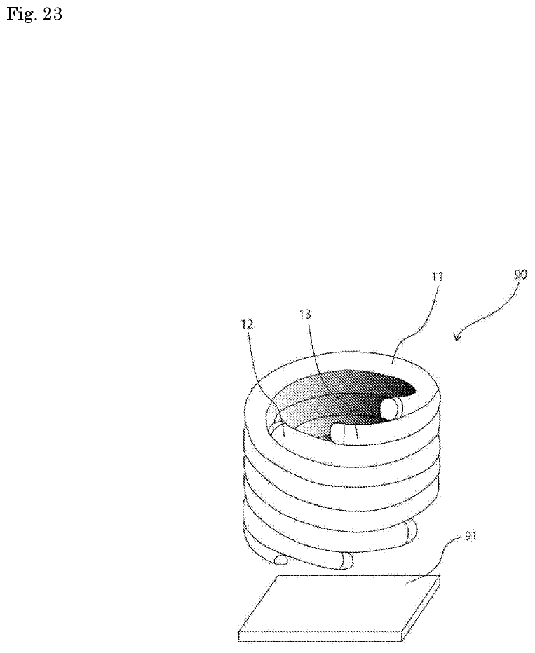

The following is an explanation about a wave control medium 90 according to Modification Example 5 of the first embodiment of the present technique with reference to FIG. 23. FIG. 23 is a perspective view of the wave control medium 90. The wave control medium 90 differs from the wave control medium 80 in that a plate is arranged orthogonally to the axis of the composite helical structure consisting of the first to third three-dimensional microstructures 11, 12, and 13. The other constitutions of the wave control medium 90 are the same as the constitutions of the wave control medium 80.

As illustrated in FIG. 23, the wave control medium 90 is provided with a plate-shaped thin wire plate 91 orthogonal to the axis of the composite helical structure outside the composite helical structure. The plate 91 is arranged separately from the second three-dimensional microstructure 12 by only a minute interval.

In the wave control medium 90, the electric field direction of the applied electric wave is coincident with the vibration direction of electrons, which is the extending direction of the plate 91, and the magnetic field direction of the applied electric wave is coincident with the magnetic force direction induced electromagnetically by the annular current flowing through the first and second three-dimensional microstructures 11 and 12. At this time, the plate 91 functions to the electric field, and the first and second three-dimensional microstructures 11 and 12 function to the magnetic field. In other words, electrons vibrating along the plate 91 function with respect to the electric field. Furthermore, when the annular current occurs by electrons vibrating along the first and second three-dimensional microstructures 11 and 12, the magnetic force is induced on the axis of the first and second three-dimensional microstructures 11 and 12 by the principle of electromagnetic induction, and, as a result, the first and second three-dimensional microstructures 11 and 12 function with respect to the magnetic field.

As such, functioning for the electric field is to control the relative permittivity εᵣ, and functioning for the magnetic field is to control the relative permeability μᵣ. Accordingly, the wave control medium 90 can control the relative permittivity and/or relative permeability to the desired values with a high degree of freedom by combining a plurality of microstructures.

The wave control medium 90 according to the present modification example exhibits the same effect as the wave control medium 80.

### 9. WAVE CONTROL MEDIUM ACCORDING TO MODIFICATION EXAMPLE 6 OF FIRST EMBODIMENT (COMBINATION WITH SPHERE STRUCTURE)

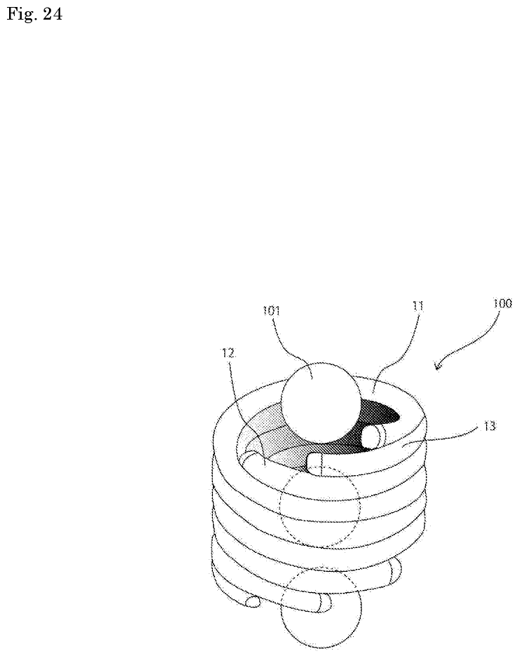

The following is an explanation about the configuration example of a wave control medium 100 according to Modification Example 6 of the first embodiment of the present technique. FIG. 24 is a perspective view of the wave control medium 100 according to Example 6. The difference between the wave control medium 100 and the wave control medium 10 according to Example 1 is that a spherical structure is combined with a composite helical structure consisting of the first to third three-dimensional microstructures 11, 12, and 13. The other constitutions of the wave control medium 100 are the same as the constitutions of the wave control medium 10.

As illustrated in FIG. 24, the wave control medium 100 is provided with a plurality of spheres 101 arranged on the axis of the composite helical structure in the extending direction of the axis. The spheres 101 are arranged separately from the composite helical structure by only a minute interval.

The spheres 101 are formed of a material selected from any one of metals, dielectrics, magnetic materials, semiconductors, and superconductors, or a combination of two or more of these. The material of the spheres 101 may be the same as or different from the materials of the first and second three-dimensional microstructures 11 and 12. The material of the spheres 101 may be the same as or different from the material of the third three-dimensional microstructure 13. Furthermore, the number of spheres 101 is not limited and may be any number. It is noted that the spheres 101 may be placed outside the composite helical structure.

In the wave control medium 100, the electric field direction of the applied electric wave is coincident with the vibration direction of electrons, which is the arranged direction of the spheres 101, and the magnetic field direction of the applied electric wave is orthogonal to the magnetic force direction induced electromagnetically by the annular current flowing through the first and second three-dimensional microstructures 11 and 12. At this time, the spheres 101 function to the magnetic field, and the first and second three-dimensional microstructures 11 and 12 function to the electric field. In other words, electrons vibrating along the spheres 101 function with respect to the magnetic field. Furthermore, the first and second three-dimensional microstructures 11 and 12 function with respect to the electric field.

According to the wave control medium 100 of the present embodiment, in addition to the same effect as the wave control medium 10 according to Example 1, the roles of the functions can be shared, and the relative permeability and/or relative permittivity can be fine-tuned by combining the sphere 101 when it is difficult to obtain the desired properties only by the composite helical structure. Furthermore, the wave control medium 100 also has the role of a capacitor between the spheres 101 and the composite helical structure, and, therefore, the capacitance can be increased more greatly than the wave control medium 10.

### 10. ELECTROMAGNETIC WAVE CONTROL MEMBER ACCORDING TO EXAMPLES 1 AND 2 OF SECOND EMBODIMENT

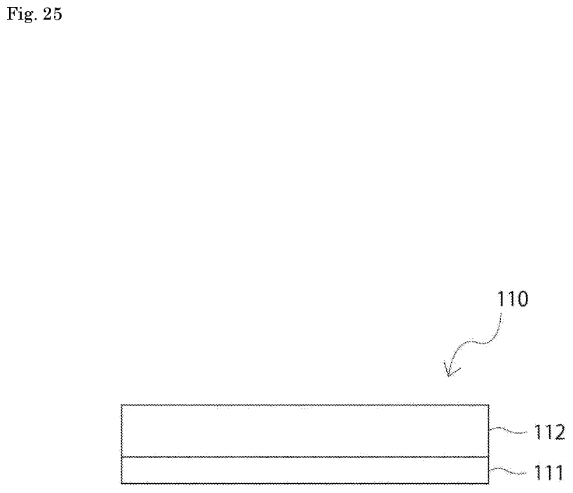

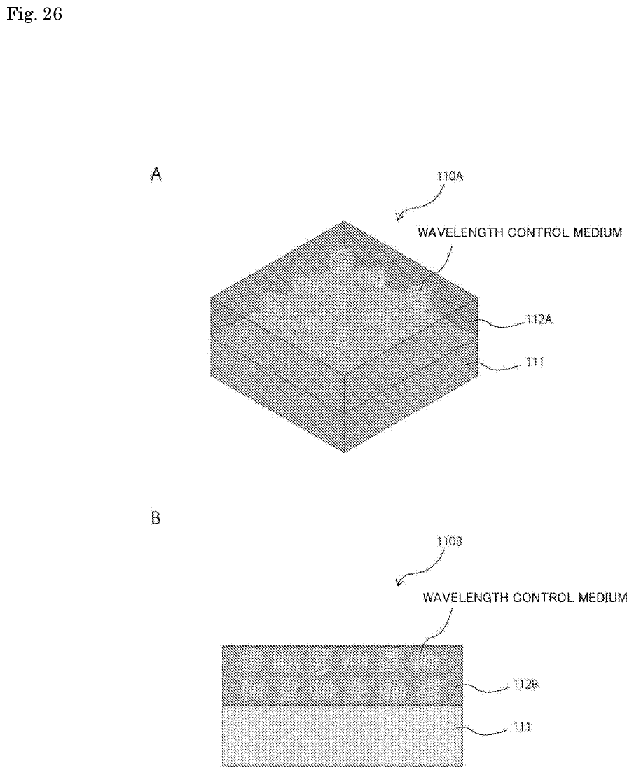

The following is an explanation about the electromagnetic wave absorbing member 110 (110A and 110B) according to Examples 1 and 2 of a second embodiment of the present technique with reference to FIG. 25, FIG. 26A, and FIG. 26B. FIG. 25 is a cross-sectional view perpendicular to the extending direction illustrating configuration examples (Examples 1 and 2) of the electromagnetic wave absorbing member 110 according to the present embodiment. FIG. 26A is an internal transparent perspective view of the electromagnetic absorbing sheet according to Example 1 of the second embodiment of the present technique. FIG. 26B is an internal transparent side view of the electromagnetic absorbing sheet according to Example 2 of the second embodiment of the present technique.

As illustrated in FIG. 25, the sheet-shaped electromagnetic wave absorbing member 110 (electromagnetic wave control member) has a cross-section perpendicular to the extending direction of a horizontally spreading rectangular shape. The electromagnetic wave absorbing member 110 is provided with a support 111 at the lower part and the metamaterial 112 above the support 111. The support 111 is formed of a metal, a dielectric, or a resin.

As illustrated in FIG. 26A, the metamaterial 112A according to Example 1 has a plurality of dispersed wave control media according to any of the examples or the modification examples of the first embodiment.

As illustrated in FIG. 26B, in the metamaterial 112B according to Example 2, wave control media according to any of the examples or the modification examples of the first embodiment are integrated in an array.

The electromagnetic wave absorbing member 110 can absorb irradiated electromagnetic waves by controlling the refractive index in the direction of absorbing the electromagnetic wave by the metamaterial 112. Furthermore, the electromagnetic wave absorbing member 110 can also be used as an electromagnetic wave shielding member (electromagnetic wave control member) that shields the irradiated electromagnetic wave by controlling the refractive index in the direction of shielding the electromagnetic wave by the wave control medium 112. Furthermore, the electromagnetic wave absorbing member 110 can be applied to sensors, such as ETCs or radars.

### 11. ELECTROMAGNETIC WAVE WAVEGUIDE ACCORDING TO EXAMPLES 1 AND 2 OF THIRD EMBODIMENT

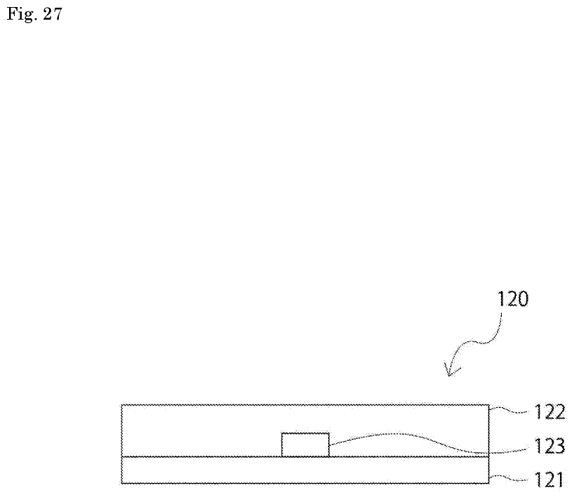

The following is an explanation about the configuration example (Example 1) of an electromagnetic wave waveguide 120 according to Example 1 of the third embodiment of the present technique with reference to FIG. 27. FIG. 27 is a cross-sectional view perpendicular to the extending direction illustrating the electromagnetic wave waveguide 120 according to Example 1.

### Example 1

As illustrated in FIG. 27, the electromagnetic wave waveguide 120 has a cross-section perpendicular to the extending direction of a horizontally spreading rectangular shape. The electromagnetic wave waveguide 120 is provided with a support 121 at the lower part and a medium 122 of silicon dioxide (SiO₂) or a dielectric above the support 121. The support 121 is formed of silicon (Si), a metal, a dielectric, or a resin.

At the position in contact with the support 121 at the central part of the medium 122, a waveguide 123 with a cross-section of a horizontally spreading rectangular shape is provided. The waveguide 123 is formed of a metamaterial in which wave control media of any of the examples or any of the modification examples of the first embodiment are integrated in arrays, or a plurality of the wave control media is dispersedly arranged. It is noted that the shapes of the electromagnetic wave waveguide 120 and the waveguide 123 are not limited to those of the present embodiment and may be cylindrical shapes and the like.

The electromagnetic wave waveguide 120 can control the refractive index of the electromagnetic wave guided to the waveguide 123 by the above constitution.

Furthermore, the electromagnetic wave waveguide 120 may be installed in a computation element.

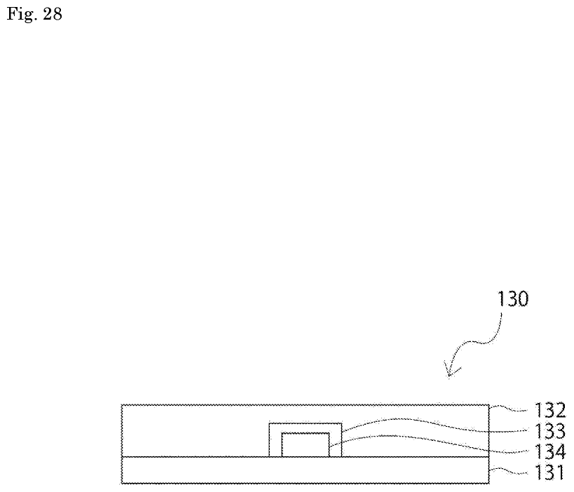

FIG. 28 is a cross-sectional view perpendicular to the extending direction illustrating the electromagnetic wave waveguide 130 according to Example 2. The electromagnetic wave waveguide 130 differs from the electromagnetic wave waveguide 120 in that a layer of a material other than the wave control medium is formed in the waveguide. The overall shape of the electromagnetic wave waveguide 130 is the same as the electromagnetic wave waveguide 120.

As illustrated in FIG. 28, the electromagnetic wave waveguide 130 has a cross-section perpendicular to the extending direction of a horizontally spreading rectangular shape. The electromagnetic wave waveguide 130 is provided with a support 131 at the lower part and a medium 132 of silicon dioxide (SiO₂) or a dielectric above the support 131. The support 131 is formed of a metal, a dielectric, or a resin.

At the position in contact with the support 131 at the central part of the medium 132, a waveguide 133 with a cross-section of a horizontally spreading rectangular shape is provided. The waveguide 133 is formed by a metamaterial, in which any of the wave control media 10 to 100 described above are integrated in arrays, or a plurality of the wave control media may be dispersedly arranged. Furthermore, at the position in contact with the support 131 at the central part of the waveguide 133, a medium layer 134 of silicon (Si) or a resin with the same shape as the waveguide 133.

The electromagnetic wave waveguide 130 can control the refractive index of the electromagnetic wave guided to the waveguide 133 by the above constitution.

### 12. FRACTIONAL BANDWIDTH

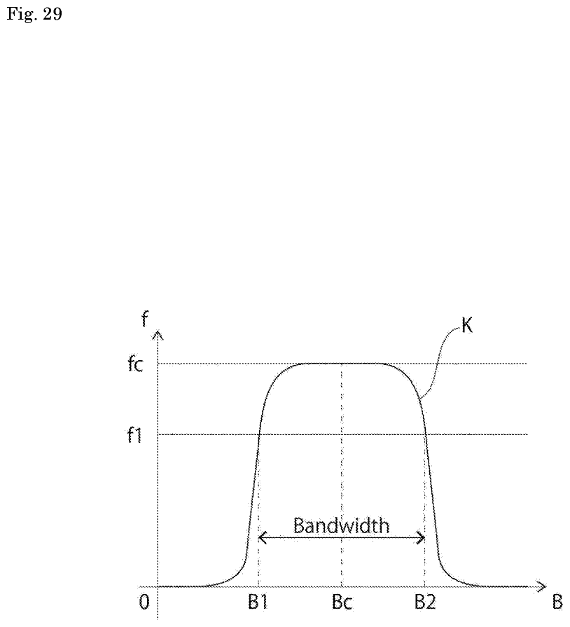

The following is an explanation about the fractional bandwidth of a metamaterial having the wave control medium according to the above first embodiment (including the examples and the modification examples) of the present technique with reference to FIG. 29. FIG. 29 is a graph explaining one example of the fractional bandwidth of a metamaterial having the wave control medium according to the first embodiment of the present technique.

The vertical axis of the graph of FIG. 29 represents a frequency f, and the horizontal axis represents a band B of the frequency. The curve K in FIG. 29 shows the relationship between the bandwidth B and the frequency f of the metamaterial having the wave control medium according to the above first embodiment.

From the curve K, the fractional bandwidth of the metamaterial is calculated. Here, the term “bandwidth” refers to the distance between the bandwidths at the frequency of 2^{-1/2} of the peak frequency, and the term “fractional bandwidth” refers to the value obtained by dividing the bandwidth by the peak frequency, which is the central frequency.

On the curve K, the peak frequency is fc when the bandwidth is Bc, and the frequency of 2^{-1/2} of the peak frequency is f₁ when the bandwidths are B₁ and B₂. Accordingly, on the curve K, the bandwidth is B₂−B₁, and the fractional bandwidth is (B₂−B₁)/fc.

From the above, the wave control medium according to the above first embodiment is optimal when the distance in the longitudinal direction and/or the diameter of the cross-section of the wave control medium is less than 1/10 of the wavelength of the wave, and the fractional bandwidth of the response is equal to or greater than 30%. Accordingly, the above first embodiment can provide a metamaterial provided with the wave control medium according to the above first embodiment and having a distance in the longitudinal direction of less than 1/10 of the wavelength of the wave and a fractional bandwidth of the response of equal to or greater than 30%. It is noted that, in this wave control element, the wave control media may be integrated in arrays, or a plurality of the wave control media may be dispersedly arranged.

### 13. OTHER MODIFICATIONS OF FIRST EMBODIMENT

In the above first embodiment, the wave control medium has a three-dimensional structure composed of a combination of the first to third three-dimensional microstructures, but the wave control medium is not limited thereto. For example, the wave control medium may have a three-dimensional structure in which a least one three-dimensional microstructure (for example, a helical member, a sphere, or the like), a least one one-dimensional microstructure (for example, a wire), and/or a least one two-dimensional microstructure (for example, a plate, a coil, or the like) are combined.

For example, the wave control medium may be provided with a three-dimensional structure in which two, or four or more three-dimensional microstructures are combined. Specifically, each of the wave control media 10, 20, 30, and 40 according to Examples 1 to 4 of the first embodiment may be provided with a composite three-dimensional structure with a combination of a plurality of three-dimensional structures in which the first to third three-dimensional microstructures are combined.

At least one of the first to third three-dimensional microstructures may have a three-dimensional shape other than helical shapes.

The first to third three-dimensional microstructures may extend while sandwiching the third three-dimensional microstructure with the first and second three-dimensional microstructures at least in the radial direction and the axial direction.

The wave control media 10 and 20 of Examples 1 and 2 may be provided with a spiral and helical three-dimensional structure in which the first to third three-dimensional microstructures are formed in a spiral shape.

At least one of the first, second, and third three-dimensional microstructures may be composed of a plurality of polymer fibers.

At least one of the first, second, and third three-dimensional microstructures may be a composite helical member in which a plurality of helical members are combined.

A wave control medium having a composite helical structure and a metamaterial including the wave control medium as a unit structure, as illustrated in FIG. 10B, may be used.

The first and second three-dimensional microstructures (for example, two helical members) may extend while facing each other. For example, the first and second three-dimensional microstructures may constitute a capacitor via an insulating material (gas, solid, liquid) disposed in the region of the space between the first and second three-dimensional microstructures.

The electrospinning device in the device for manufacturing the wave control medium may have two nozzles or four or more nozzles. For example, when two nozzles are used, a composite helical structure consisting of at least three three-dimensional microstructures (for example, helical members) can be formed by ejecting raw materials from at least one nozzle at different timings.

The first, second, and third three-dimensional microstructures each may be reticular or may be reticular as a whole.

At least one of the first, second, and third three-dimensional microstructures may be microporous.

At least one of the first, second, and third three-dimensional microstructures may be in a state in which a plurality of structures are stacked.

The perimeter (one cycle length) of the first, second, and third three-dimensional microstructures viewed from an axis direction may be equal to or longer than the wavelength of a wave to be controlled.

The wave control medium may include a plurality of three-dimensional structures composed of a combination of the first, second, and third three-dimensional microstructures. For example, at least two of the plurality of three-dimensional structures may be juxtaposed in a state where the axes are substantially parallel or substantially orthogonal. At least two of the plurality of the three-dimensional structures may be different in size and/or shape. For example, when each of the plurality of three-dimensional structures is helical, at least two three-dimensional structures may be different in at least one of the length in the axis direction, helical pitch, helical diameter, and line diameter. For example, the wave control medium may have a helical three-dimensional structure and a spiral and helical shape with a constant helical diameter.

The wave control medium may be manufactured by a manufacturing method including a self-organization step by drying a block copolymer or mixed polymer solution composed of a combination of different polymers.

The wave control medium may be manufactured by a manufacturing method including a 3D printing step of a photo-curable resin, a thermosetting resin, a light soluble resin, or a heat soluble resin.

The wave control medium may be manufactured by a manufacturing method including the step of forming metal thin lines by patterning metal on a substrate and a step of spontaneously contracting the metal thin lines.

The wave control medium may be manufactured by a manufacturing method including a spontaneous growth step of a metal structure from a surface-treated part patterned on a substrate with metal.

Some of the constitutions of the wave control medium according to the examples and the modification examples of the above first embodiment may be combined within the range that they do not contradict each other. For example, at least one of a wire structure, a plate structure, and a sphere structure may be combined with the wavelength control media 10, 20, 30, and 40 according to Examples 1 to 4.

### 14. OTHER APPLICATIONS AND USES

The following is an explanation about applications and uses of the metamaterial having the wave control medium according to the above first embodiment of the present technique.

The metamaterial having the wave control medium according to the embodiments described above may be applied, in addition to the uses described above, to transmitting/receiving devices configured to perform transmission and reception or light-receiving/emitting devices configured to receive and emit light, small antennas, low-profile antennas, frequency selection filters, artificial magnetic conductors, electro band gap members, noise suppression members, isolators, electric wave lenses, radar members, optical lenses, optical films, terahertz optical elements, electric wave and optical camouflage/invisible members, heat dissipation members, heat shielding members, heat storage members, electromagnetic wave modulation/demodulation, wavelength conversion, etc., electromagnetic wave reflection (electromagnetic wave control), electromagnetic wave transmission (electromagnetic wave control), nonlinear devices, speakers, energy absorption materials, blackbody materials, extinction materials, energy conversion materials, electric wave lenses, optical lenses, color filters, frequency selection filters, electromagnetic wave reflection materials, beam phase control devices, and the like.

The present technique can employ the following constitutions.
(1) A wave control medium including a three-dimensional structure that includes a combination of a plurality of microstructures.
(2) The wave control medium according to (1), wherein at least one of the plurality of microstructures is a three-dimensional microstructure.
(3) The wave control medium according to (2), wherein the three-dimensional microstructure is coiled.
(4) The wave control medium according to any one of (1) to (3), wherein at least two of the plurality of microstructures are three-dimensional microstructures.
(5) The wave control medium according to (4), wherein at least two of the three-dimensional microstructures include first and second three-dimensional microstructures extending while maintaining a distance from each other.
(6) The wave control medium according to (5), wherein the first and second three-dimensional microstructures constitute a capacitor.
(7) The wave control device according to (5) or (6), wherein the first and second three-dimensional microstructures are electrically conductive, and at least two of the three-dimensional microstructures further include an insulating third three-dimensional microstructure extending while being sandwiched by the first and second three-dimensional microstructures.
(8) The wave control medium according to (7), wherein each of the first, second, and third three-dimensional microstructures is composed of at least one polymer fiber.
(9) The wave control medium according to any one of (4) to (8), wherein the first and second three-dimensional microstructures are composed of an inorganic polymer, and the third three-dimensional microstructure is composed of an organic polymer.
(10) The wave control medium according to any one of (7) to (9), wherein each of the first, second, and third three-dimensional microstructures is helical.
(11) The wave control medium according to any one of (7) to (10), wherein the first, second, and third three-dimensional microstructures are arranged substantially coaxially.
(12) The wave control medium according to any one of (7) to (11), wherein the first, second, and third three-dimensional microstructures extend while sandwiching the third three-dimensional microstructure by the first and second three-dimensional microstructures at least in a radial direction.
(13) The wave control medium according to any one of (7) to (12), wherein the first, second, and third three-dimensional structures have different diameters.
(14) The wave control medium according to any one of (7) to (13), wherein the first, second, and third three-dimensional microstructures extend while sandwiching the third three-dimensional microstructure by the first and second three-dimensional microstructures at least in an axial direction.
(15) The wave control medium according to (7) to (12) or (14), wherein the first, second, and third three-dimensional microstructures have an identical diameter.
(16) The wave control medium according to any one of (7) to (12) and (14), wherein the first, second, and third three-dimensional microstructures are concentrically stacked to form a single helix.
(17) The wave control medium according to any one of (10) to (16), wherein the first, second, and third three-dimensional microstructures are spiral.
(18) The wave control medium according to any one of (7) to (17), wherein the first, second, and third three-dimensional microstructures are reticular.
(19) The wave control medium according to any one of (7) to (18), wherein the first, second, and third three-dimensional microstructures are multi-porous.
(20) The wave control medium according to any one of (7) to (19), wherein the first, second, and third three-dimensional microstructures are in a state in which a plurality of structures are stacked.
(21) The wave control medium according to any one of (7) to (20), wherein the first, second, and third three-dimensional microstructures each have a perimeter viewed from an axis direction equal to or longer than a wavelength of a wave to be controlled.
(22) The wave control medium according to any one of (1) to (21), further including another microstructure in any of a wire shape, a plate shape, or a sphere shape.
(23) The wave control medium according to any one of (7) to (22), including a plurality of three-dimensional structures composed of a combination of the first, second, and third three-dimensional microstructures.
(24) The wave control medium according to (23), wherein at least two of the plurality of the three-dimensional structures are different in size and/or shape.
(25) The wave control medium according to (23) or (24), wherein each of a plurality of the three-dimensional structures is helical and at least two of the plurality of three-dimensional structures have different diameters.
(26) A metamaterial including the wave control medium according to any one of (1) to (25).
(27) The metamaterial according to (26), wherein the wave control medium is integrated in arrays.
(28) The metamaterial according to (26), wherein a plurality of the wave control media are dispersedly arranged.
(29) The metamaterial according to any one of (26) to (28), wherein the fractional bandwidth of response is 30% or more, and a diameter of a cross-section of the wave control medium is less than 1/10 of a wavelength of the incident wave.
(30) An electromagnetic wave control member including the metamaterial according to any one of (26) to (29).
(31) A sensor including the electromagnetic wave control member according to (30).
(32) An electromagnetic wave waveguide including the metamaterial according to any one of (26) to (29).
(33) A computation element including the electromagnetic wave waveguide according to (32).
(34) A transmitting/receiving device configured to perform transmission and reception using the metamaterial according to any one of (26) to (29).
(35) A light-receiving/emitting device configured to receive and emit light using the metamaterial according to any one of (26) to (29).
(36) An energy absorption material including the metamaterial according to any one of (26) to (29).
(37) A blackbody material including the metamaterial according to any one of (26) to (29).
(38) An extinction material including the metamaterial according to any one of (26) to (29).
(39) An energy conversion material including the metamaterial according to any one of (26) to (29).
(40) An electric wave lens including the metamaterial according to any one of (26) to (29).
(41) An optical lens including the metamaterial according to any one of (26) to (29).
(42) A color filter including the metamaterial according to any one of (26) to (29).
(43) A frequency selection filter including the metamaterial according to any one of (26) to (29).
(44) An electromagnetic wave reflection material including the metamaterial according to any one of (26) to (29).
(45) A beam phase control device including the metamaterial according to any one of (26) to (29).
(46) An electrospinning device including:
a plurality of nozzles configured to eject a raw material,
a collector, and
a power source configured to apply a voltage between the plurality of nozzles and the collector.
(47) The electrospinning device according to (46), which forms a composite helical structure composed of a combination of at least three helical members formed by converting the raw materials ejected from the plurality of nozzles into helical fibers.
(48) The electrospinning device according to (46) or (47), wherein the plurality of nozzles include first and second nozzles configured to eject, as the raw material, a solution containing a complex of a metal precursor and a polymer as a solute or melt in which the complex is molten and a third nozzle configured to eject, as the raw material, a polymer solution containing an organic polymer as a solute or a molten polymer in which an organic polymer is molten.
(49) The electrospinning device according to (48), wherein a composite helical structure composed of a combination of at least three helical members is formed by converting the raw material ejected from the plurality of nozzles into helical fibers such that the raw materials ejected from the first and second nozzles sandwich the raw material ejected from the third nozzle.
(50) A device for manufacturing a wave control medium, including:
the electrospinning device according to any one of (46) to (49) and
a heat treatment device configured to heat the composite helical structure formed by the electrospinning device.
(51) A method for manufacturing a wave control medium, including the steps of: ejecting multiple kinds of raw materials,
forming a composite helical structure composed of a combination of at least three helical members by charging the multiple kinds of raw materials and converting the raw materials into helical fibers, and
heating the composite helical structure to selectively mineralize some of the helical members among the at least three helical members.
(52) The method for manufacturing a wave control medium according to (51), wherein the multiple kinds of raw materials include first and second raw materials that are solutions containing a complex of a metal precursor and a polymer as a solute or melt in which the complex is molten, and a third raw material that is a polymer solution containing an organic polymer as a solute or a molten polymer in which an organic polymer is molten.
(53) The method for manufacturing a wave control medium according to (52), wherein the forming step converts the multiple kinds of raw materials into helical fibers such that the first and second raw materials sandwich the third raw material to form a composite helical structure composed of a combination of at least three helical members.
(54) A method for manufacturing a wave control medium, including a self-organization step by drying a block copolymer or a mixed polymer solution composed of a combination of different polymers.
(55) A method for manufacturing a wave control medium, including a 3D printing step of a photo-curable resin, a thermosetting resin, a light soluble resin, or a heat soluble resin.
(56) A method for manufacturing a wave control medium, including the steps of patterning metal on a substrate to form a thin metal line and spontaneously contracting the thin metal line.
(57) A method for manufacturing a wave control medium, including a spontaneous growth step of a metal structure from a surface-treated part patterned on a substrate with metal.

### REFERENCE SIGNS LIST

10, 20, 30, 40, 50, 60, 70, 80, 90, 100 Wave control medium
11, 21, 31, 41 First three-dimensional microstructure
12, 22, 32, 42 Second three-dimensional microstructure
13, 23, 33, 43 Third three-dimensional microstructure
51, 61, 71 Wire
81, 91 Plate
101 Sphere
110 Electromagnetic wave absorption member (Electromagnetic wave control member)
112, 112A, 112B Metamaterial
120, 130 Electromagnetic wave waveguide
1000 Device for manufacturing wave control medium
1100 Electrospinning device
1111a First nozzle
1111b Second nozzle
1111c Third nozzle
1112 Collector
1113 Power source
1200 Heat treatment device

1. A wave control medium comprising a three-dimensional structure that includes a combination of a plurality of microstructures.

2. The wave control medium according to claim 1, wherein at least one of the plurality of microstructures is a three-dimensional microstructure.

3. The wave control medium according to claim 2, wherein the three-dimensional microstructure is coiled.

4. The wave control medium according to claim 1, wherein at least two of the plurality of microstructures are three-dimensional microstructures.

5. The wave control medium according to claim 4, wherein at least two of the three-dimensional microstructures include first and second three-dimensional microstructures extending while maintaining a distance from each other.

6. The wave control medium according to claim 5, wherein the first and second three-dimensional microstructures constitute a capacitor.

7. The wave control device according to claim 5, wherein the first and second three-dimensional microstructures are electrically conductive, and
at least two of the three-dimensional microstructures further include an insulating third three-dimensional microstructure extending while being sandwiched by the first and second three-dimensional microstructures.

8. The wave control medium according to claim 7, wherein each of the first, second, and third three-dimensional microstructures is composed of at least one polymer fiber.

9. The wave control medium according to claim 8, wherein the first and second three-dimensional microstructures are composed of an inorganic polymer and the third three-dimensional microstructure is composed of an organic polymer.

10. The wave control medium according to claim 7, wherein each of the first, second, and third three-dimensional microstructures is helical.

11. The wave control medium according to claim 10, wherein the first, second, and third three-dimensional microstructures are arranged substantially coaxially.

12. The wave control medium according to claim 10, wherein the first, second, and third three-dimensional microstructures extend while sandwiching the third three-dimensional microstructure by the first and second three-dimensional microstructures at least in a radial direction.

13. The wave control medium according to claim 12, wherein the first, second, and third three-dimensional microstructures have different diameters.

14. The wave control medium according to claim 10, wherein the first, second, and third three-dimensional microstructures extend while sandwiching the third three-dimensional microstructure by the first and second three-dimensional microstructures at least in an axial direction.

15. The wave control medium according to claim 14, wherein the first, second, and third three-dimensional microstructures have an identical diameter.

16. The wave control medium according to claim 10, wherein the first, second, and third three-dimensional microstructures are substantially concentrically stacked to form a single helix.

17. The wave control medium according to claim 10, wherein the first, second, and third three-dimensional microstructures are spiral.

18. The wave control medium according to claim 10, wherein the first, second, and third three-dimensional microstructures are reticular.

19. The wave control medium according to claim 10, wherein the first, second, and third three-dimensional microstructures are multi-porous.

20. The wave control medium according to claim 10, wherein the first, second, and third three-dimensional microstructures are in a state in which a plurality of structures are stacked.

21. The wave control medium according to claim 10, wherein the first, second, and third three-dimensional microstructures each have a perimeter viewed from an axis direction equal to or longer than a wavelength of a wave to be controlled.

22. The wave control medium according to claim 1, further comprising another microstructure in any of a wire shape, a plate shape, or a sphere shape.

23. The wave control medium according to claim 7, comprising a plurality of three-dimensional structures composed of a combination of the first, second, and third three-dimensional microstructures.

24. The wave control medium according to claim 23, wherein at least two of the plurality of the three-dimensional structures are different in size and/or shape.

25. The wave control medium according to claim 23, wherein each of the plurality of the three-dimensional structures is helical and at least two of the plurality of three-dimensional structures have different diameters.

26. A metamaterial comprising the wave control medium according to claim 1.

27. The metamaterial according to claim 26, wherein the wave control medium is integrated in arrays.

28. The metamaterial according to claim 26, wherein a plurality of the wave control media are dispersedly arranged.

29. The metamaterial according to claim 26, wherein a fractional bandwidth of response is 30% or more, and a diameter of a cross-section of the wave control medium is less than 1/10 of a wavelength of an incident wave.

30. An electromagnetic wave control member comprising the metamaterial according to claim 26.

31. A sensor comprising the electromagnetic wave control member according to claim 30.

32. An electromagnetic wave waveguide comprising the metamaterial according to claim 26.

33. A computation element comprising the electromagnetic wave waveguide according to claim 32.

34. A transmitting/receiving device configured to perform transmission and reception using the metamaterial according to claim 26.

35. A light-receiving/emitting device configured to receive and emit light using the metamaterial according to claim 26.

36. An energy absorption material comprising the metamaterial according to claim 26.

37. A blackbody material comprising the metamaterial according to claim 26.

38. An extinction material comprising the metamaterial according to claim 26.

39. An energy conversion material comprising the metamaterial according to claim 26.

40. An electric wave lens comprising the metamaterial according to claim 26.

41. An optical lens comprising the metamaterial according to claim 26.

42. A color filter comprising the metamaterial according to claim 26.

43. A frequency selection filter comprising the metamaterial according to claim 26.

44. An electromagnetic wave reflection material comprising the metamaterial according to claim 26.

45. A beam phase control device comprising the metamaterial according to claim 26.

46. An electrospinning device comprising:
a plurality of nozzles configured to eject a raw material,
a collector, and
a power source configured to apply a voltage between the plurality of nozzles and the collector.

47. The electrospinning device according to claim 46, which forms a composite helical structure composed of a combination of at least three helical members by converting the raw materials ejected from the plurality of nozzles into helical fibers.

48. The electrospinning device according to claim 47, wherein
the plurality of nozzles include
first and second nozzles configured to eject, as the raw material, a solution containing a complex of a metal precursor and a polymer as a solute or melt in which the complex is molten and
a third nozzle configured to eject, as the raw material, a polymer solution containing an organic polymer as a solute or a molten polymer in which an organic polymer is molten.

49. The electrospinning device according to claim 48, wherein a composite helical structure composed of a combination of at least three helical members is formed by converting the raw material ejected from the plurality of nozzles into helical fibers such that the raw materials ejected from the first and second nozzles sandwich the raw material ejected from the third nozzle.

50. A device for manufacturing a wave control medium, comprising:
the electrospinning device according to claim 46 and
a heat treatment device configured to heat the composite helical structure formed by the electrospinning device.

51. A method for manufacturing a wave control medium, comprising the steps of:
ejecting multiple kinds of raw materials,
forming a composite helical structure composed of a combination of at least three helical members by charging the multiple kinds of raw materials and converting the raw materials into helical fibers, and
heating the composite helical structure to selectively mineralize some of the helical members among the at least three helical members.

52. The method for manufacturing a wave control medium according to claim 51, wherein
the multiple kinds of raw materials include
first and second raw materials that are solutions containing a complex of a metal precursor and a polymer as a solute or melt in which the complex is molten, and
a third raw material that is a polymer solution containing an organic polymer as a solute or a molten polymer in which an organic polymer is molten.

53. The method for manufacturing a wave control medium according to claim 52, wherein the forming step converts the multiple kinds of raw materials into helical fibers such that the first and second raw materials sandwich the third raw material to produce a composite helical structure composed of a combination of at least three helical members.

54. A method for manufacturing a wave control medium, comprising a self-organization step by drying a block copolymer or a mixed polymer solution composed of a combination of different polymers.

55. A method for manufacturing a wave control medium, comprising a 3D printing step of a photo-curable resin, a thermosetting resin, a light soluble resin, or a heat soluble resin.

56. A method for manufacturing a wave control medium, comprising the steps of patterning metal on a substrate to form a thin metal line and
spontaneously contracting the thin metal line.

57. A method for manufacturing a wave control medium, comprising a spontaneous growth step of a metal structure from a surface-treated part patterned on a substrate with metal.
